(19) United States
(12) Patent Application Publication
(10) Pub. No.: US 2025/0390426 A1
(43) Pub. Date: Dec. 25, 2025

(54) Delayed Parity Write for Redundant Storage Across Namespaces in Data Storage Devices

(71) Applicant: Western Digital Technologies, Inc., San Jose, CA (US)

(72) Inventors: Dinesh Babu, Bangalore (IN); Sridhar Sabesan, Bangalore (IN); Pavan Gururaj, Bangalore (IN)

(21) Appl. No.: 18/750,605

(22) Filed: Jun. 21, 2024

(51) Int. Cl. G06F 12/02

(52) U.S. Cl. CPC G06F 12/0223

(57) ABSTRACT

Systems and methods for delayed parity write for redundant storage of data in redundant array of independent disk (RAID) arrays, such as across namespaces configured in a RAID set are described. The RAID set includes storage locations distributed across data storage devices and/or namespaces on those data storage devices for receiving host data. Host data is stored in RAID stripe sets of blocks distributed among the RAID set storage locations as the host data is received. Storage of corresponding parity blocks is delayed until a parity write trigger event. Responsive to determining the parity write trigger event, the parity blocks for the RAID stripes are stored to corresponding storage locations.

### TECHNICAL FIELD

The present disclosure generally relates to operation management for redundant array of independent disks (RAID) configurations in data storage devices and, more particularly, to delayed parity operations to support quality of service and load balancing.

### BACKGROUND

Multi-device storage systems utilize multiple discrete data storage devices, generally disk drives (solid-state drives (SSD), hard disk drives (HDD), hybrid drives, tape drives, etc.) for storing large quantities of data. These multi-device storage systems are generally arranged in an array of drives interconnected by a common communication fabric and, in many cases, controlled by a storage controller, redundant array of independent disks (RAID) controller, or general controller, for coordinating storage and system activities across the array of drives. RAID is a data storage virtualization technology that combines multiple physical disk drive components into one or more logical units for the purposes of data redundancy, performance improvement, or both. RAID volumes are typically implemented in RAID3, RAID4, RAID5, RAID6, RAID50, RAID60, or related RAID configurations where parity calculation is involved for a write operation. Parity is a mathematical method of defining the accuracy in data transmission between computers to ensure that data is not lost or altered. In RAID volumes, parity is calculated during runtime and written as a follow-on during write operations. This process can have a major impact on the performance of the RAID volumes. Different vendors have implemented dedicated or distributed parity in their RAID volumes. However, the parity calculation and writing process remains a performance bottleneck in many implementations.

Therefore, there still exists a need for a RAID management system that allows for delayed parity write operations, thereby improving performance by reducing the impact of parity calculation and data transfer by storing parity during configurable times.

### SUMMARY

Various aspects for RAID storage to one or more data storage devices using delayed parity are described. More particularly, host data blocks are written to RAID stripes as they are received, while parity blocks are not written until a parity write trigger event is determined, which may include trigger events based on various predetermined parameters or on-the-fly parameters for determining device health, workload, or other factors. Various ways of configuring the parity write trigger event may enable system administrators to better manage the workload related to parity calculation and storage.

One general aspect includes a system that includes at least one controller configured to, alone or in combination: determine a redundant array of independent disks (RAID) configuration may include a RAID set of storage locations distributed among at least one data storage device, where each data storage device of the at least one data storage device may include a non-volatile storage medium configured to store host data for at least one host system; store, based on the RAID configuration, host data in at least one stripe set of blocks in the RAID set of storage locations; delay, responsive to storing the host data in the at least one stripe set of blocks and until a parity write trigger event is determined, storing at least one parity block for each stripe set of blocks in the at least one stripe set of blocks; determine that the parity write trigger event has occurred; and store, responsive to the parity write trigger event, the at least one parity block for each stripe set of blocks in the at least one stripe set of blocks.

Implementations may include one or more of the following features. The set of data storage locations may include data storage locations in a plurality of namespaces allocated in the at least one data storage device; the at least one controller may be further configured to, alone or in combination, determine a plurality of host connections to the plurality of namespaces in the at least one data storage device; and each stripe set of blocks and corresponding at least one parity block for the at least one stripe set of blocks may be distributed among the plurality of namespaces. Each namespace of the plurality of namespaces may have a first allocated capacity; at least one namespace of the plurality of namespaces may allocate a portion of the first allocated capacity to a floating namespace pool; and the at least one controller may be further configured to, alone or in combination, selectively allocate capacity from the floating namespace pool to at least one namespace of the plurality of namespaces for storing the at least one parity block. The at least one controller may be further configured to, alone or in combination, determine, based on at least one user configured parameter received from a user, at least one of the following: a time delay value for determining the parity write trigger event; a scheduled time value for determining the parity write trigger event; a workload threshold value for determining the parity write trigger event; a device risk threshold value for determining the parity write trigger event; and a manual event parameter for determining the parity write trigger event. The at least one controller may be further configured to, alone or in combination, use the at least one user configured parameter to determine the parity write trigger event. The at least one stripe set of blocks may include a first stripe set of blocks. The at least one controller may be further configured to, alone or in combination: receive the host data for the first stripe set of blocks; determine a first priority value associated with the host data for the first stripe set of blocks; receive the host data for a second stripe set of blocks; determine a second priority value associated with host data for the second stripe set of blocks; generate, based on the second priority value indicating no delayed parity, a second set of parity blocks for the second stripe set of blocks; store, without delay, the second set of parity blocks for the second stripe set of blocks; and generate, based on the first priority value indicating delayed parity and responsive to the parity write trigger event, a first set of parity blocks for the first stripe set of blocks. Storing the at least one parity block for each stripe set of blocks in the at least one stripe set of blocks may include storing the first set of parity blocks. The at least one controller may be further configured to, alone or in combination: store, in a RAID stripe data structure, block location identifiers for each stripe set of blocks in the at least one stripe set of blocks; identify, in the RAID stripe data structure, the at least one stripe set of blocks with a delayed parity identifier; store, in the RAID stripe data structure and responsive to the parity write trigger event, parity block location identifiers for each of the at least one parity block for each stripe set of blocks in the at least one stripe set of blocks; and remove, responsive to storing the parity block location identifiers, corresponding delayed parity identifiers for each stripe set of blocks in the at least one stripe set of blocks. Determining the parity write trigger event may include a current time value meeting a time-based threshold value; the time-based threshold value may be selected from a time delay value and a scheduled time value; and the at least one controller may be further configured to, alone or in combination, monitor the current time value, and compare the current time value to the time-based threshold value for each stripe set of blocks to determine the parity write trigger event for that stripe set of blocks. Determining the parity write trigger event may include a current workload value meeting a workload threshold value, and the at least one controller may be further configured to, alone or in combination: monitor the current workload value; and compare the current workload value to the workload threshold value for the at least one stripe set of blocks. Determining the parity write trigger event may include a device risk value associated with the at least one data storage device hosting the RAID set of storage locations meeting a device risk threshold value, and the at least one controller may be further configured to, alone or in combination: monitor the device risk value for the at least one data storage device; and compare the device risk value to the device risk threshold value for the at least one stripe set of blocks. The system may include the plurality of data storage devices in communication with the at least one controller; the at least one data storage device may include the plurality of data storage devices; monitoring the device risk value may include receiving at least one device parameter from each data storage device of the plurality of data storage devices and determining, based on the at least one device parameter, the device risk value for each data storage device of the plurality of data storage devices; the parity write trigger event may occur if a number of device risk values for the plurality of data storage devices meet the device risk threshold value; and the number of device risk values may be based on a recoverable number of failures for the RAID configuration.

Another general aspect includes a computer-implemented method that includes: determining a redundant array of independent disks (RAID) configuration may include a RAID set of storage locations distributed among at least one data storage device, where each data storage device of the at least one data storage device may include a non-volatile storage medium configured to store host data for at least one host system; storing, based on the RAID configuration, host data in at least one stripe set of blocks in the RAID set of storage locations; delaying, responsive to storing the host data in the at least one stripe set of blocks and until a parity write trigger event is determined, storing at least one parity block for each stripe set of blocks in the at least one stripe set of blocks; determining that the parity write trigger event has occurred; and storing, responsive to the parity write trigger event, the at least one parity block for each stripe set of blocks in the at least one stripe set of blocks.

Implementations may include one or more of the following features. The computer-implemented method may include determining a plurality of host connections to a plurality of namespaces allocated in the at least one data storage device, where: the set of data storage locations may include data storage locations in the plurality of namespaces; and each stripe set of blocks and corresponding at least one parity block for the at least one stripe set of blocks are distributed among the plurality of namespaces. The computer-implemented method may include selectively allocating capacity from a floating namespace pool to at least one namespace of the plurality of namespaces for storing the at least one parity block, where each namespace of the plurality of namespaces has a first allocated capacity and at least one namespace of the plurality of namespaces allocates a portion of the first allocated capacity to the floating namespace pool. The computer-implemented method may include determining, based on at least one user configured parameter received from a user, at least one of the following: a time delay value for determining the parity write trigger event; a scheduled time value for determining the parity write trigger event; a workload threshold value for determining the parity write trigger event; a device risk threshold value for determining the parity write trigger event; and a manual event parameter for determining the parity write trigger event. The computer-implemented method may include using the at least one user configured parameter to determine the parity write trigger event. The computer-implemented method may include: receiving the host data for a first stripe set of blocks, where at least one stripe set of blocks may include the first stripe set of blocks; determining a first priority value associated with the host data for the first stripe set of blocks; receiving the host data for a second stripe set of blocks; determining a second priority value associated with host data for the second stripe set of blocks; generating, based on the second priority value indicating no delayed parity, a second set of parity blocks for the second stripe set of blocks; storing, without delay, the second set of parity blocks for the second stripe set of blocks; and generating, based on the first priority value indicating delayed parity and responsive to the parity write trigger event, a first set of parity blocks for the first stripe set of blocks, where storing the at least one parity block for each stripe set of blocks in the at least one stripe set of blocks includes storing the first set of parity blocks. The computer-implemented method may include: storing, in a RAID stripe data structure, block location identifiers for each stripe set of blocks in the at least one stripe set of blocks; identifying, in the RAID stripe data structure, the at least one stripe set of blocks with a delayed parity identifier; storing, in the RAID stripe data structure and responsive to the parity write trigger event, parity block location identifiers for each of the at least one parity block for each stripe set of blocks in the at least one stripe set of blocks; and removing, responsive to storing the parity block location identifiers, corresponding delayed parity identifiers for each stripe set of blocks in the at least one stripe set of blocks. The computer-implemented method may include: monitoring a current time value; and comparing the current time value to a time-based threshold value for each stripe set of blocks to determine the parity write trigger event for that stripe set of blocks, where determining the parity write trigger event may include the current time value meeting the time-based threshold value and the time-based threshold value is selected from a time delay value and a scheduled time value. The computer-implemented method may include monitoring a current workload value; and comparing the current workload value to a workload threshold value for the at least one stripe set of blocks, where determining the parity write trigger event may include the current workload value meeting the workload threshold value. The computer-implemented method may include monitoring a device risk value for the at least one data storage device; and comparing the device risk value to a device risk threshold value for the at least one stripe set of blocks, where determining the parity write trigger event may include the device risk value associated with the at least one data storage device hosting the RAID set of storage locations meeting the device risk threshold value.

Still another general aspect includes a system that includes a processor; a memory; means for determining a redundant array of independent disks (RAID) configuration may include a RAID set of storage locations distributed among at least one data storage device, where each data storage device of the at least one data storage device may include a non-volatile storage medium configured to store host data for at least one host system; means for storing, based on the RAID configuration, host data in at least one stripe set of blocks in the RAID set of storage locations; means for delaying, responsive to storing the host data in the at least one stripe set of blocks and until a parity write trigger event is determined, storing at least one parity block for each stripe set of blocks in the at least one stripe set of blocks; means for determining that the parity write trigger event has occurred; and means for storing, responsive to the parity write trigger event, the at least one parity block for each stripe set of blocks in the at least one stripe set of blocks.

The various embodiments advantageously apply the teachings of data storage devices and/or multi-device storage systems to improve the functionality of such computer systems. The various embodiments include operations to overcome or at least reduce the issues previously encountered in storage arrays and/or systems and, accordingly, are more reliable and/or efficient than other computing systems. That is, the various embodiments disclosed herein include hardware and/or software with functionality to improve utilization of input/output (I/O) and processing resources in individual data storage devices and across RAID sets of data storage devices in a multi-device storage system, such as by using configurable delayed parity storage to shift parity operations away from workload constrained times. Accordingly, the embodiments disclosed herein provide various improvements to storage networks and/or storage systems.

It should be understood that language used in the present disclosure has been principally selected for readability and instructional purposes, and not to limit the scope of the subject matter disclosed herein.

### BRIEF DESCRIPTION OF THE DRAWINGS

FIG. 1 schematically illustrates a multi-device storage system implementing delayed parity write in a RAID configuration.

FIG. 2a schematically illustrates namespaces with different operating characteristics in a data storage device.

FIG. 2b schematically illustrates namespace allocations with contributions to a floating namespace pool.

FIG. 3 is a flowchart of an example method for implementing delayed parity write in a RAID configuration.

FIG. 4A schematically illustrates a hierarchy of capacity usage based on RAID configuration across namespaces supported by a floating namespace pool.

FIG. 4B schematically illustrates an example RAID configuration across four namespaces supporting dynamically allocated capacity.

FIG. 5 schematically illustrates some elements of the storage system of FIG. 1 in more detail.

FIG. 6 is a flowchart of an example method for implementing delayed parity write in RAID configurations.

FIG. 7 is a flowchart of an example method for managing RAID configurations and delayed parity storage using a floating namespace pool for a RAID set based on namespaces.

FIG. 8 is a flowchart of an example method for managing delayed parity configurations.

FIG. 9 is a flowchart of an example method for managing delayed parity writes in the RAID stripe metadata of a RAID system.

### DETAILED DESCRIPTION

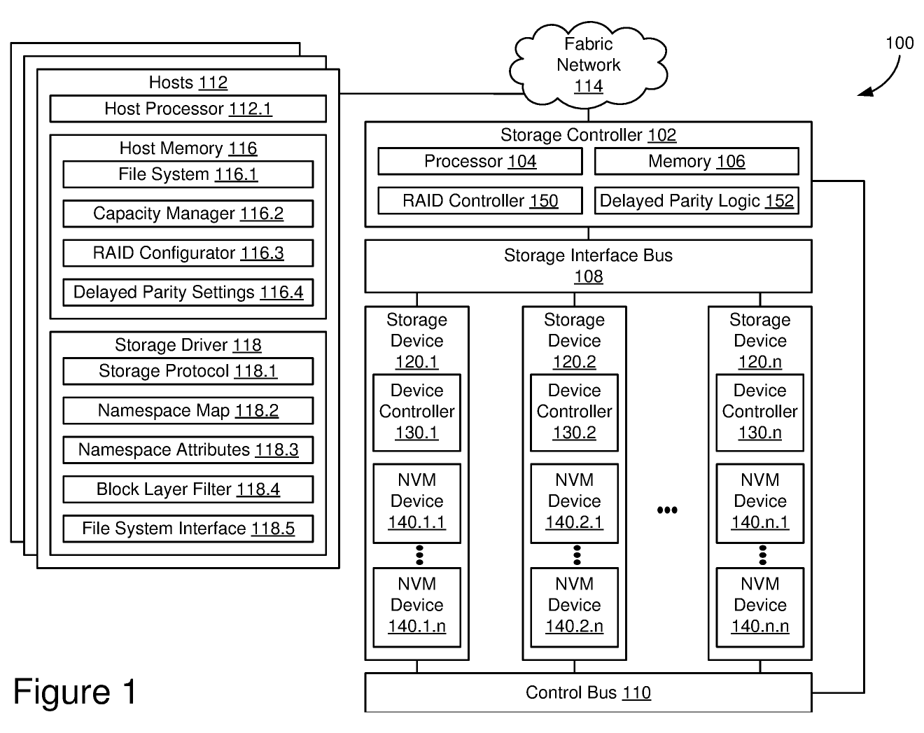

FIG. 1 shows an embodiment of an example data storage system 100 with multiple data storage devices 120 supporting a plurality of host systems 112 through storage controller 102. While some example features are illustrated, various other features have not been illustrated for the sake of brevity and so as not to obscure pertinent aspects of the example embodiments disclosed herein. To that end, as a non-limiting example, data storage system 100 may include one or more data storage devices 120 (also sometimes called information storage devices, storage devices, disk drives, or drives) configured in a storage node with storage controller 102. In some embodiments, storage devices 120 may be configured in a server, storage array blade, all flash array appliance, or similar storage unit for use in data center storage racks or chassis. Storage devices 120 may interface with one or more host nodes or host systems 112 and provide data storage and retrieval capabilities for or through those host systems. In some embodiments, storage devices 120 may be configured in a storage hierarchy that includes storage nodes, storage controllers (such as storage controller 102), and/or other intermediate components between storage devices 120 and host systems 112. For example, each storage controller 102 may be responsible for a corresponding set of storage devices 120 in a storage node and their respective storage devices may be connected through a corresponding backplane network or internal bus architecture including storage interface bus 108 and/or control bus 110, though only one instance of storage controller 102 and corresponding storage node components are shown. In some embodiments, storage controller 102 may include or be configured within a host bus adapter for connecting storage devices 120 to fabric network 114 for communication with host systems 112.

In the embodiment shown, a number of storage devices 120 are attached to a common storage interface bus 108 for host communication through storage controller 102. For example, storage devices 120 may include a number of drives arranged in a storage array, such as storage devices sharing a common rack, unit, or blade in a data center or the SSDs in an all flash array. In some embodiments, storage devices 120 may share a backplane network, network switch(es), and/or other hardware and software components accessed through storage interface bus 108 and/or control bus 110. For example, storage devices 120 may connect to storage interface bus 108 and/or control bus 110 through a plurality of physical port connections that define physical, transport, and other logical channels for establishing communication with the different components and subcomponents for establishing a communication channel to host 112. In some embodiments, storage interface bus 108 may provide the primary host interface for storage device management and host data transfer, and control bus 110 may include limited connectivity to the host for low-level control functions. For example, storage interface bus 108 may support peripheral component interface express (PCIe) connections to each storage device 120 and control bus 110 may use a separate physical connector or extended set of pins for connection to each storage device 120.

In some embodiments, storage devices 120 may be referred to as a peer group or peer storage devices because they are interconnected through storage interface bus 108 and/or control bus 110. In some embodiments, storage devices 120 may be configured for peer communication among storage devices 120 through storage interface bus 108, with or without the assistance of storage controller 102 and/or host systems 112. For example, storage devices 120 may be configured for direct memory access using one or more protocols, such as non-volatile memory express (NVMe), remote direct memory access (RDMA), NVMe over fabric (NVMeOF), etc., to provide command messaging and data transfer between storage devices using the high-bandwidth storage interface and storage interface bus 108.

In some embodiments, data storage devices 120 are, or include, solid-state drives (SSDs). Each data storage device 120.1-120.n may include a non-volatile memory (NVM) or device controller 130 based on compute resources (processor and memory) and a plurality of NVM or media devices 140 for data storage (e.g., one or more NVM device(s), such as one or more flash memory devices). In some embodiments, a respective data storage device 120 of the one or more data storage devices includes one or more NVM controllers, such as flash controllers or channel controllers (e.g., for storage devices having NVM devices in multiple memory channels). In some embodiments, data storage devices 120 may each be packaged in a housing, such as a multi-part sealed housing with a defined form factor and ports and/or connectors for interconnecting with storage interface bus 108 and/or control bus 110.

In some embodiments, a respective data storage device 120 may include a single medium device while in other embodiments the respective data storage device 120 includes a plurality of media devices. In some embodiments, media devices include NAND-type flash memory or NOR-type flash memory. In some embodiments, data storage device 120 may include one or more hard disk drives (HDDs). In some embodiments, data storage devices 120 may include a flash memory device, which in turn includes one or more flash memory die, one or more flash memory packages, one or more flash memory channels or the like. However, in some embodiments, one or more of the data storage devices 120 may have other types of non-volatile data storage media (e.g., phase-change random access memory (PCRAM), resistive random access memory (ReRAM), spin-transfer torque random access memory (STT-RAM), magneto-resistive random access memory (MRAM), etc.).

In some embodiments, each storage device 120 includes a device controller 130, which includes one or more processing units (also sometimes called central processing units (CPUs), processors, microprocessors, or microcontrollers) configured to execute instructions in one or more programs. In some embodiments, the one or more processors are shared by one or more components within, and in some cases, beyond the function of the device controllers and may operate alone or in combination. In some embodiments, device controllers 130 may include firmware for controlling data written to and read from media devices 140, one or more storage (or host) interface protocols for communication with other components, as well as various internal functions, such as garbage collection, wear leveling, media scans, and other memory and data maintenance. For example, device controllers 130 may include firmware for running the NVM layer of an NVMe storage protocol alongside media device interface and management functions specific to the storage device. Media devices 140 are coupled to device controllers 130 through connections that typically convey commands in addition to data, and optionally convey metadata, error correction information and/or other information in addition to data values to be stored in media devices and data values read from media devices 140. Media devices 140 may include any number (i.e., one or more) of memory devices including, without limitation, non-volatile semiconductor memory devices, such as flash memory device(s).

In some embodiments, media devices 140 in storage devices 120 are divided into a number of addressable and individually selectable blocks, sometimes called erase blocks. In some embodiments, individually selectable blocks are the minimum size erasable units in a flash memory device. In other words, each block contains the minimum number of memory cells that can be erased simultaneously (i.e., in a single erase operation). Each block is usually further divided into a plurality of pages and/or word lines, where each page or word line is typically an instance of the smallest individually accessible (readable) portion in a block. In some embodiments (e.g., using some types of flash memory), the smallest individually accessible unit of a data set, however, is a sector or codeword, which is a subunit of a page. That is, a block includes a plurality of pages, each page contains a plurality of sectors or codewords, and each sector or codeword is the minimum unit of data for reading data from the flash memory device.

A data unit may describe any size allocation of data, such as host block, data object, sector, page, multi-plane page, erase/programming block, media device/package, etc. Storage locations may include physical and/or logical locations on storage devices 120 and may be described and/or allocated at different levels of granularity depending on the storage medium, storage device/system configuration, and/or context. For example, storage locations may be allocated at a host logical block address (LBA) data unit size and addressability for host read/write purposes but managed as pages with storage device addressing managed in the media flash translation layer (FTL) in other contexts. Media segments may include physical storage locations on storage devices 120, which may also correspond to one or more logical storage locations. In some embodiments, media segments may include a continuous series of physical storage location, such as adjacent data units on a storage medium, and, for flash memory devices, may correspond to one or more media erase or programming blocks. A logical data group may include a plurality of logical data units that may be grouped on a logical basis, regardless of storage location, such as data objects, files, or other logical data constructs composed of multiple host blocks.

In some embodiments, storage controller 102 may be coupled to data storage devices 120 through a network interface that is part of host fabric network 114 and includes storage interface bus 108 as a host fabric interface. In some embodiments, host systems 112 are coupled to data storage system 100 through fabric network 114 and storage controller 102 may include a storage network interface, host bus adapter, or other interface capable of supporting communications with multiple host systems 112. Fabric network 114 may include a wired and/or wireless network (e.g., public and/or private computer networks in any number and/or configuration) which may be coupled in a suitable way for transferring data. For example, the fabric network may include any means of a conventional data communication network such as a local area network (LAN), a wide area network (WAN), a telephone network, such as the public switched telephone network (PSTN), an intranet, the internet, or any other suitable communication network or combination of communication networks. From the perspective of storage devices 120, storage interface bus 108 may be referred to as a host interface bus and provides a host data path between storage devices 120 and host systems 112, through storage controller 102 and/or an alternative interface to fabric network 114.

Host systems 112, or a respective host in a system having multiple hosts, may be any suitable computer device, such as a computer, a computer server, a laptop computer, a tablet device, a netbook, an internet kiosk, a personal digital assistant, a mobile phone, a smart phone, a gaming device, or any other computing device. Host systems 112 are sometimes called a host, client, or client system. In some embodiments, host systems 112 are server systems, such as a server system in a data center. In some embodiments, the one or more host systems 112 are one or more host devices distinct from a storage node housing the plurality of storage devices 120 and/or storage controller 102. In some embodiments, host systems 112 may include a plurality of host systems owned, operated, and/or hosting applications belonging to a plurality of entities and supporting one or more quality of service (QoS) standards for those entities and their applications. Host systems 112 may be configured to store and access data in the plurality of storage devices 120 in a multi-tenant configuration with shared storage resource pools accessed through namespaces and corresponding host connections to those host connections.

Host systems 112 may include one or more central processing units (CPUs) or host processors 112.1 for executing compute operations, storage management operations, and/or instructions for accessing storage devices 120, such as storage commands, through fabric network 114. Host processors 112.1 may include any number of processors or processor cores operating alone or in combination. Host systems 112 may include host memories 116 for storing instructions for execution by host processors 112.1, such as dynamic random access memory (DRAM) devices to provide operating memory for host systems 112. Host memories 116 may include any combination of volatile and non-volatile memory devices for supporting the operations of host systems 112.

In some configurations, each host memory 116 may include a host file system 116.1 for managing host data storage to non-volatile memory. Host file system 116.1 may be configured in one or more volumes and corresponding data units, such as files, data blocks, and/or data objects, with known capacities and data sizes. Host file system 116.1 may use at least one storage driver 118 to access storage resources. In some configurations, those storage resources may include both local non-volatile memory devices in host system 112 and host data stored in remote data storage devices, such as storage devices 120, that are accessed using a direct memory access storage protocol, such as NVMe.

In some configurations, each host memory 116 may include a capacity manager 116.2 for managing the storage capacity of one or more storage devices or systems attached to the host and accessible through file system 116.1. For example, capacity manager 116.2 may include a user application integrated in or interfacing with file system 116.1. In some configurations, capacity manager 116.2 may enable attachment to one or more namespaces defined and accessed according to the protocols of storage driver 118. Capacity manager 116.2 may receive configuration and usage information for the namespaces attached through storage driver 118 and mapped to file system 116.1, such as the capacity of the namespace and its current usage or fill level. Capacity manager 116.2 may also receive notifications when available capacity in file system 116.1 and include an interface for requesting additional namespaces from attached storage systems. For example, a namespace manager may determine aggregate unused capacity allocated to a floating namespace pool from storage devices 120 and make it available through virtual namespaces published to hosts 112 for accessing additional capacity.

In some configurations, each host memory 116 may include a RAID configurator 116.3 for configuring redundant data protection for host data stored to storage devices 120. For example, storage controller 102 may include a RAID controller 150 that received host data, allocates it to RAID data blocks, calculates parity blocks, and stores RAID stripes in a distributed fashion among storage devices 120 and/or namespaces therein. In some configurations, one or more hosts 112 may include RAID controller functions as a storage application in host memory 116 and/or feature of storage driver 118. RAID configurator 116.3 may include a user interface for defining RAID configurations for one or more redundant data schemes to support host data storage. RAID configurator 116.3 may allow a user or other system resource to determine target namespaces for a RAID set, RAID type (e.g., RAID 1, RAID 4, RAID 5, RAID 6, etc.), number of RAID nodes, and parameters for parity, block size, stripe logic, and other aspects of each RAID configuration. In some configurations, RAID configurator 116.3 may communicate one or more parameters for a RAID configuration to RAID controller 150 in storage controller 102 for redundant protection of host data stored in data storage devices 120. In some configurations, host memory 116 may include delayed parity settings 116.4 as a separate set of configuration parameters or as part of the RAID configuration managed by RAID configurator 116.3. For example, delayed parity settings 116.4 may include parameters for enabling or disabling delayed parity features for one or more RAID configurations, priority thresholds for selectively applying delayed parity to different classes of host data, time-based thresholds for delaying or scheduling parity write trigger events, selecting workload thresholds and models for parity write trigger events, selecting device risk thresholds and models for parity write trigger events, enabling or disabling manual parity write trigger events, host notifications, and other configuration settings for managing delayed parity.

Storage driver 118 may be instantiated in the kernel layer of the host operating system for host systems 112. Storage driver 118 may support one or more storage protocols 118.1 for interfacing with data storage devices, such as storage devices 120. Storage driver 118 may rely on one or more interface standards, such as PCIe, ethernet, fibre channel, compute express link (CXL), etc., to provide physical and transport connection through fabric network 114 to storage devices 120 and use a storage protocol over those standard connections to store and access host data stored in storage devices 120. In some configurations, storage protocol 118.1 may be based on defining fixed capacity namespaces on storage devices 120 that are accessed through dynamic host connections that are attached to the host system according to the protocol. For example, host connections may be requested by host systems 112 for accessing a namespace using queue pairs allocated in a host memory buffer and supported by a storage device instantiating that namespace. Storage devices 120 may be configured to support a predefined maximum number of namespaces and a predefined maximum number of host connections. When a namespace is created, it is defined with an initial allocated capacity value and that capacity value is provided to host systems 112 for use in defining the corresponding capacity in file system 116.1. In some configurations, storage driver 118 may include or access a namespace map 118.2 for all of the namespaces available to and/or attached to that host system. Namespace map 118.2 may include entries mapping the connected namespaces, their capacities, and host LBAs to corresponding file system volumes and/or data units. These namespace attributes 118.3 may be used by storage driver 118 to store and access host data on behalf of host systems 112 and may be selectively provided to file system 116.1 through a file system interface 118.5 to manage the block layer storage capacity and its availability for host applications.

Because namespace sizes or capacities are generally regarded as fixed once they are created, a block layer filter 118.4 may be used between the storage device/namespace interface of storage protocol 118.1 and file system interface 118.5 to manage dynamic changes in namespace capacity. Block layer filter 118.4 may be configured to receive a notification from storage devices 120 and/or storage controller 102 and provide the interface to support host file system resizing. Block layer filter 118.4 may be a thin layer residing in the kernel space as a storage driver module. Block layer filter 118.4 may monitor for asynchronous commands from the storage node (using the storage protocol) that include a namespace capacity change notification. Once an async command with the namespace capacity change notification is received by block layer filter 118.4, it may parse a capacity change value and/or an updated namespace capacity value from the notification and generate a resize command to host file system 116.1. Based on the resize command, file system 116.1 may adjust the capacity of the volume mapped to that namespace. Block layer filter 118.4 may also update namespace attributes 118.3 and namespace map 118.2, as appropriate.

Storage controller 102 may include one or more central processing units (CPUs) or processors 104 for executing compute operations, storage management operations, and/or instructions for accessing storage devices 120 through storage interface bus 108. In some embodiments, processors 104 may include a plurality of processor cores which may be assigned or allocated to parallel processing tasks and/or processing threads for different storage operations and/or host storage connections. In some embodiments, processor 104 may be configured to execute fabric interface for communications through fabric network 114 and/or storage interface protocols for communication through storage interface bus 108 and/or control bus 110. In some embodiments, a separate network interface unit and/or storage interface unit (not shown) may provide the network interface protocol and/or storage interface protocol and related processor and memory resources.

Storage controller 102 may include a memory 106 configured to support a plurality of queue pairs allocated between host systems 112 and storage devices 120 to manage command queues and storage queues for host storage operations against host data in storage devices 120. In some embodiments, memory 106 may include one or more DRAM devices for use by storage devices 120 for command, management parameter, and/or host data storage and transfer. In some embodiments, storage devices 120 may be configured for direct memory access (DMA), such as using RDMA protocols, over storage interface bus 108.

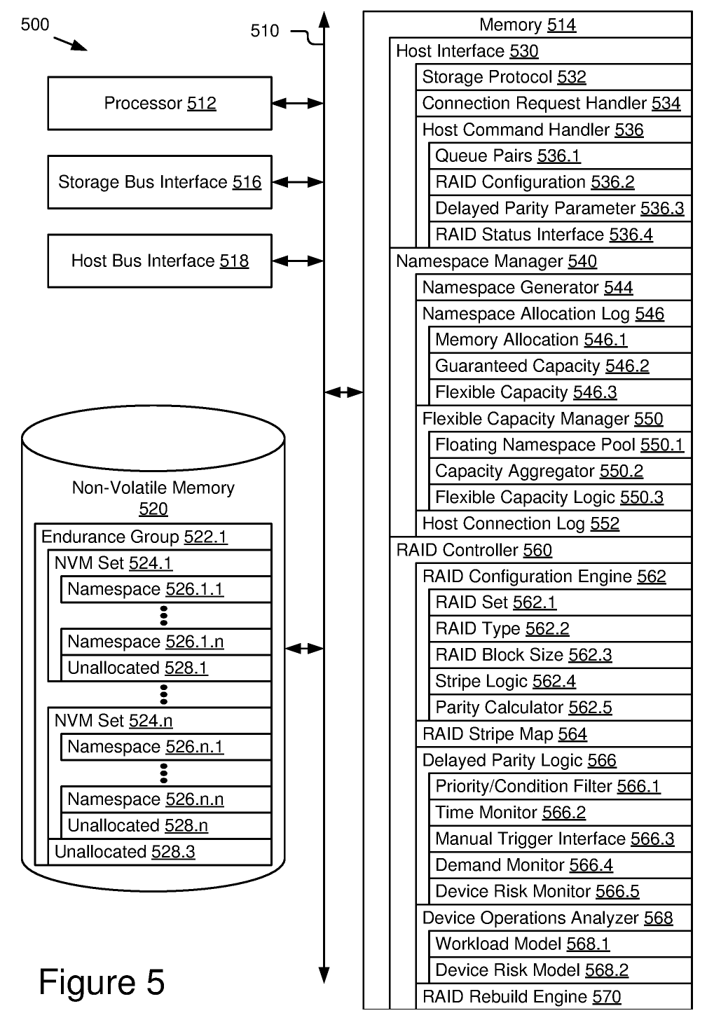

In some configurations, storage controller 102 may include or interface with a RAID controller 150 for redundant storage of host data to storage devices 120. For example, RAID controller 150 may include functions for determining a RAID configuration, storing host data to storage devices 120 according to that RAID configuration, and/or recovering host data (e.g., RAID rebuild) following the loss, failure, or other disruption of one of the components storing RAID protected data. In some configurations, RAID controller 150 may support RAID configurations across namespaces as RAID nodes, where a set of namespaces provide the RAID set used in the RAID configurations. Namespaces in a RAID set may be distributed across storage devices 120, where a single namespace is selected from each storage device to reduce the risk of simultaneous failure due to device failure. In some RAID configurations, multiple failures may be tolerated and use of multiple namespaces on the same device may be acceptable. Similarly, different NVMe devices 140 may be considered “drives” for failure tolerance and defining namespaces on different NVMe devices may suffice for the desired fault tolerance. In some configurations, a RAID configuration may be defined solely within a single data storage device 120, with all namespaces in the RAID set being selected in the same data storage device, though possible distributed among NVMe devices within that storage device. Storage controller 102 and/or RAID controller 150 may include or interface with delayed parity logic 152 for executing delayed parity storage. For example, based on delayed parity settings 116.4, delayed parity logic 152 may delay the generation and/or storage of parity blocks as host data blocks are written to corresponding RAID stripes and monitor for parity write trigger events to initiate writing of the corresponding parity blocks to complete the RAID stripes at a later time. An example RAID controller including delayed parity logic will be described further with regard to FIG. 5.

In some embodiments, data storage system 100 includes one or more processors, one or more types of memory, a display and/or other user interface components such as a keyboard, a touch screen display, a mouse, a track-pad, and/or any number of supplemental devices to add functionality. In some embodiments, data storage system 100 does not have a display and other user interface components.

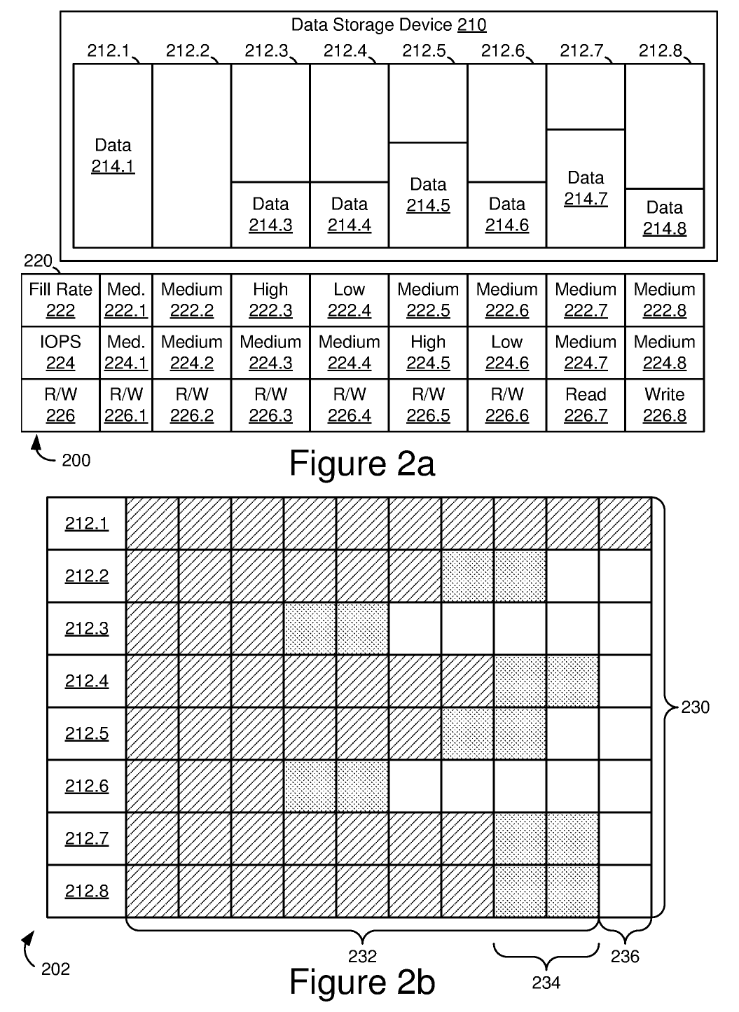

FIGS. 2a and 2b show schematic representations of how the namespaces 212 in an example data storage device 210, such as one of storage devices 120 in FIG. 1, may be used by the corresponding host systems and support dynamic capacity allocation. FIG. 2a shows a snapshot of storage space usage and operating types for namespaces 212. FIG. 2b shows the current capacity allocations for those namespaces, supporting a number of capacity units contributing to a floating namespace pool.

In the example shown, storage device 210 has been allocated across eight namespaces 212.1-212.8 having equal initial capacities. For example, storage device 210 may have a total capacity of 8 terabytes (TB) and each namespace may be created with an initial capacity of 1 TB to align with the physical capacity and interface support of the storage device. Namespace 212.1 may have used all of its allocated capacity, the filled mark for host data 214.1 at 1 TB. Namespace 212.2 may be empty or contain an amount of host data too small to represent in the figure, such as 10 gigabytes (GB). Namespaces 212.3-212.8 are shown with varying levels of corresponding host data 214.3-214.8 stored in memory locations allocated to those namespaces, representing different current filled marks for those namespaces.

Additionally, the use of each namespace may vary on other operating parameters. For example, most of the namespaces may operate with an average or medium fill rate 222, relative to each other and/or system or drive populations generally. However, two namespaces 212.3 and 212.4 may be exhibiting significant variances from the medium range. For example, namespace 212.3 may be exhibiting a high fill rate 222.3 that is over a high fill rate threshold (filling very quickly) and namespace 212.4 may be exhibiting a low fill rate 222.4 that is below a low fill rate threshold (filling very slowly). Similarly, when compared according to input/output operations per second (IOPS) 224, most of namespaces 212 may be in a medium range, but two namespaces 212.5 and 212.6 may be exhibiting significant variances from the medium range for IOPS. For example, namespace 224.5 may be exhibiting high IOPS 224.5 (e.g., 1.2 GB per second) that is above a high IOPS threshold and namespace 212.6 may be exhibiting low IOPS 224.6 (e.g., 150 megabytes (MB) per second) that is below a low IOPS threshold. When compared according to whether read operations or write operations are dominant (read/write (R/W) 226), most namespaces 212 may be in a range with relatively balanced read and write operations, but two namespaces 212.7 and 212.8 may be exhibiting significant variances from the medium range for read/write operation balance. For example, namespace 212.6 may be exhibiting read intensive operations 226.7 that are above a read operation threshold and namespace 212.8 may be exhibiting write intensive operations 226.8 that are above a write operation threshold. Similar normal ranges, variances, and thresholds may be defined for other operating parameters of the namespaces, such as sequential versus random writes/reads, write amplification/endurance metrics, time-dependent storage operation patterns, etc. Any or all of these operating metrics may contribute to operating types for managing allocation of capacity to and from a floating namespace pool.

To improve utilization of namespaces, each namespace may be identified as to whether they are able to contribute unutilized capacity to a floating capacity pool to reduce capacity starvation of namespaces with higher utilization. For example, a system administrator may set one or more flags when each namespace is created to determine whether it will participate in dynamic capacity allocation and, if so, how. Floating capacity for namespaces may consist of unused space from read-intensive namespaces and/or slow filling namespaces, along with unallocated memory locations from NVM sets and/or NVM endurance groups supported by the storage protocol. The floating capacity may not be exposed to or attached to any host, but maintained as a free pool stack of unused space, referred to as a floating namespace pool, from which the capacity can be dynamically allocated to expand any starving namespace.

In the example shown in FIG. 2B, each namespace 212 has been configured with an initial allocated capacity of ten capacity units 230. For example, if each namespace is allocated 1 TB of physical memory locations, each capacity unit would be 100 GB of memory locations. Namespaces 212, other than namespace 212.1, have been configured to support a floating namespace pool (comprised of the white capacity unit blocks). Each namespace includes a guaranteed capacity 232 and most of the namespaces include flexible capacity 236. In some configurations, guaranteed capacity 232 may include a buffer capacity 234 above a current or expected capacity usage. For example, capacity units 230 with diagonal lines may represent utilized or expected capacity, capacity units 230 with dots may represent buffer capacity, and capacity units 230 with no pattern may be available in the floating namespace pool. Guaranteed capacity 232 may be the sum of utilized or expected capacity and the buffer capacity. The floating namespace pool may be comprised of the flexible capacity units from all of the namespaces and provide an aggregate pool capacity that is the sum of those capacity units. For example, the floating namespace pool may include two capacity units from namespaces 212.2 and 212.5, five capacity units from namespaces 212.3 and 212.6, and one capacity unit from namespaces 212.4, 212,7 and 212.8, for an aggregate pool capacity of 17 capacity units. The allocations may change over time as capacity blocks from the floating namespace pool are used to expand the guaranteed capacity of namespaces that need it. For example, as fast filling namespace 212.3 receives more host data, capacity units may be allocated from the floating namespace pool to the guaranteed capacity needed for the host storage operations. The capacity may initially be claimed from the floating capacity blocks normally allocated to namespace 212.3, but may ultimately require capacity blocks from other namespaces, resulting in a guaranteed capacity larger than the initial 10 capacity units.

As described below, initial values for guaranteed storage and contributions to flexible capacity may be determined when each namespace is created. Some namespaces, such as namespace 212.1, may not participate in the floating namespace pool at all and may be configured entirely with guaranteed capacity, similar to prior namespace configurations. This may allow some namespaces to opt out of the dynamic allocation and provide guaranteed capacity for critical applications and host data. Some namespaces may use a system default for guaranteed and flexible capacity values. For example, the system may be configured to allocate a default portion of the allocated capacity to guaranteed capacity and a remaining portion to flexible capacity. In one configuration, the default guaranteed capacity may be 50% and the default flexible capacity may be 50%. So, for namespaces with the default configuration, such as namespaces 212.3 and 212.6, the initial guaranteed capacity value may be 5 capacity units and the flexible capacity value may be 5 capacity units. Some namespaces may use custom allocations of guaranteed and flexible capacity. For example, during namespace creation, the new namespace command may include custom capacity attributes to allow custom guaranteed capacity values and corresponding custom flexible capacity values. In the example shown, the remaining namespaces may have been configured with custom capacity attributes resulting in, for example, namespaces 212.2 and 212.5 having guaranteed capacity values of 8 capacity units and flexible capacity values of 2 capacity units. Additionally (as further described below), the guaranteed capacity values may change from the initial values over time as additional guaranteed capacity is allocated to namespaces that need it.

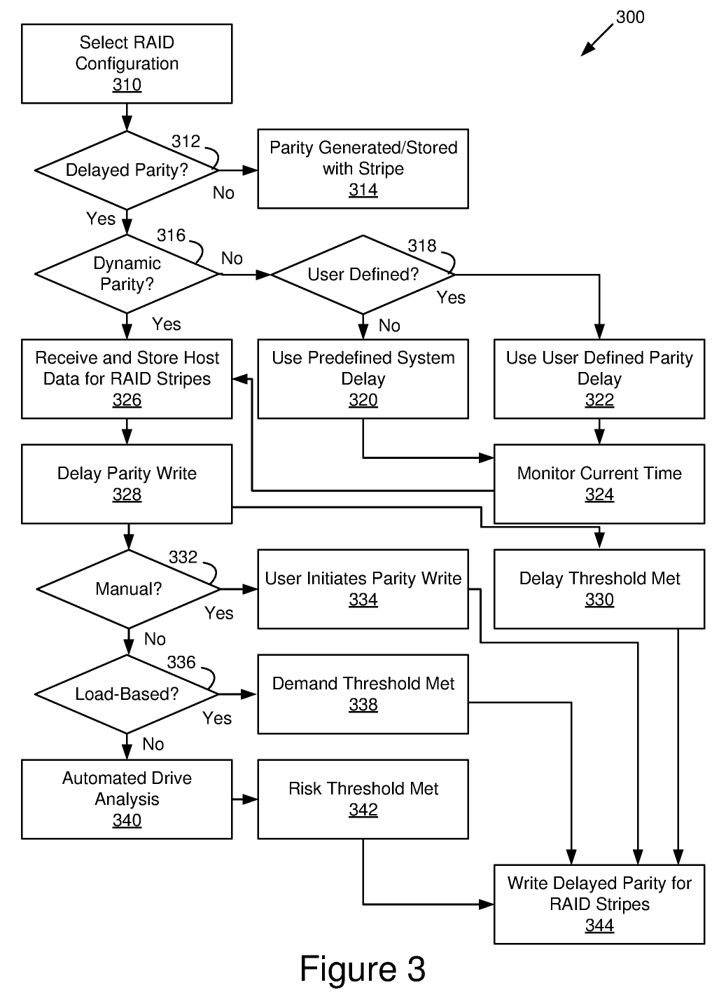

FIG. 3 illustrates a flowchart of an example method 300 for implementing delayed parity write in a RAID configuration. The method may be executed by at least one controller (operating alone or in combination) within a data storage system, which is configured to manage RAID configurations and parity storage operations. The method may culminate in the storage of the parity blocks for RAID stripes to complete those RAID stripes at a later time, effectively balancing the workload and improving system performance. Generally, the method may facilitate the delayed writing of parity blocks in a RAID set until a predetermined parity write trigger event, including dynamic device health or workload events, occurs.

At block 310, a RAID configuration is determined, comprising a RAID set of storage locations distributed among data storage devices. For example, the system may analyze the storage requirements and available resources to establish a selected RAID configuration for a class of host data.

At block 312, a decision is made on whether to use delayed parity. For example, the system may determine whether delayed parity is enabled and, in some configurations, evaluate host data priority, current workload levels, and/or device risk factors to decide if delayed parity is beneficial for the operation. If delayed parity is not enabled or the specific host data operations do not meet delayed parity thresholds, method 300 may proceed to block 314. If delayed parity is enabled and the specific host operation is subject to delayed parity, method 300 may proceed to block 316.

At block 314, parity is generated and stored with the stripe set of blocks without delay. For example, in scenarios where delayed parity is not selected, the system may proceed with immediate parity calculation and storage alongside the host data to complete the RAID stripe without delay.

At block 316, a dynamic parity decision is made. For example, the system may determine, based on user configuration, whether to dynamically determine parity write trigger events based on real-time analysis of system performance, workload thresholds, and/or device risk or to use a more fixed, time-based approach. If dynamic parity is enabled, method 300 may proceed to block 326. If dynamic parity is not enabled, method 300 may proceed to block 318.

At block 318, a determination is made on whether the parity delay is user-defined. For example, the system may check for user-configured parameters that dictate the amount of time the parity writes are delayed. If user-defined time-based thresholds are provided, method 300 may proceed to block 322. If no user-defined time-based thresholds are provided, method 300 may proceed to block 320.

At block 320, a predefined system delay for parity write is used. For example, the system may implement a standard delay threshold for parity writes that has been preconfigured based on historical data and system performance metrics.

At block 322, a user-defined parity delay is used. For example, the system may apply a custom delay threshold for parity writes as specified by the user through a configuration interface.

At block 324, the current time is monitored. For example, the system may continuously track the system clock to determine the appropriate timing for parity write operations based on the time-based thresholds.

At block 326, host data for RAID stripes is received and stored as host data blocks. For example, the system may allocate host data to RAID stripes as they are received from host systems and store the host data blocks to corresponding storage locations for that RAID stripe.

At block 328, the storage of parity blocks for the RAID stripe is delayed. For example, the system may temporarily withhold parity block storage to prioritize other system operations or to wait for a more opportune time.

At block 330, a decision is made on whether a delay threshold has been met. For example, the system may evaluate if the current time or workload conditions have reached the point where delayed parity blocks can now be stored.

At block 332, a decision is made on whether manual event trigger are enabled. For example, the system configuration may enable a system administrator to manually initiate the storage of parity blocks for RAID stripes through a management console. If a manual parity write is enabled, method 300 may proceed to block 334. If manual parity write is not enabled, method 300 may proceed to block 336.

At block 334, the user initiates the parity write. For example, the system may receive a command from the user to begin storing parity blocks that were previously delayed.

At block 336, a decision is made on whether the dynamic parity is load-based. For example, the system configuration may enable the system administrator to select workload-based or device risk models to use for dynamically determining parity write trigger events. If load-based delay is selected, method 300 may proceed to block 338. If load-based delay is not selected, method 300 may proceed to block 340.

At block 338, a demand threshold is met for parity write. For example, the system may determine if the current workload on the data storage devices has reached a demand threshold where resources are available and delayed parity can be stored.

At block 340, automated drive analysis is performed. For example, the system may automatically analyze drive health and performance metrics to determine the risk of failure among the date storage devices.

At block 342, a risk threshold is met for parity write. For example, the system may compare the calculated device risk values against a predefined device risk threshold to decide if parity blocks should be written before the likelihood of failure and data loss for the unprotected host data blocks is too high.

At block 344, delayed parity is written for the RAID stripes. For example, once any conditions for delayed parity writing are satisfied, the system may proceed to store the parity blocks for each stripe set of blocks in the RAID set, completing those RAID stripes.

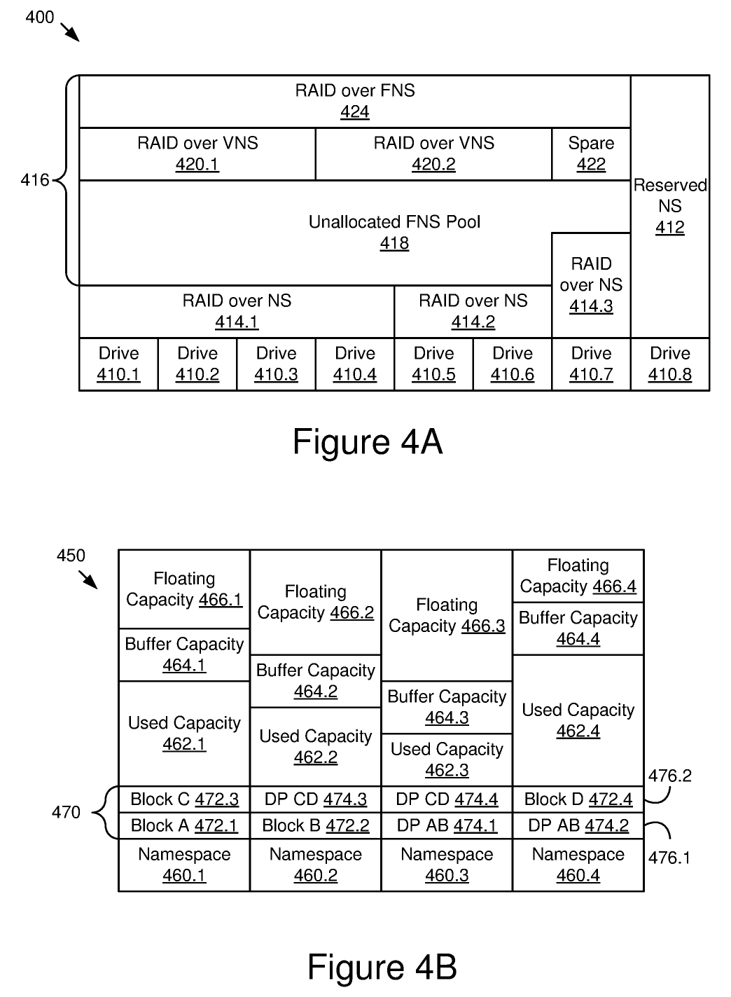

As shown in FIG. 4A, a set of storage devices (e.g., drives 410) in a storage node 400 may support a hierarchy of capacity allocation and usage based on a floating namespace pool. In the example shown, drives 410.1-410.8 are storage devices in storage node 400, such as an all flash array. The namespaces of drive 410.8 have been configured as dedicated namespaces reserved for use by the host systems attached to those namespaces. For example, reserved namespaces 412 may include namespaces created without their flexible capacity flag enabled, so act as conventional namespaces without dynamic capacity and neither contribute to or receive capacity from the floating namespace pool. Storage node 400 has been configured with a number of RAIDs over namespaces 414.1-414.3. For example, RAID 414.1 comprises namespaces in drives 410.1-410.4, RAID 414.2 comprises namespaces in drives 410.5-410.6, and RAID 414.3 comprises multiple namespaces in drive 410.7.

Above RAIDs 414, flexible capacity and unallocated capacity of endurance groups contribute to an initial floating namespace pool 416. Storage node 400 may maintain an unallocated floating namespace pool 418 to support the buffer capacity and flexibility of the namespaces in RAIDs 414. Storage node 400 may also allocated floating namespace capacity from initial floating namespace pool 416 to virtual namespaces that support RAID over virtual namespaces 420.1 and 420.2. These virtual namespaces may be comprised of capacity from the floating namespace pool aggregated across any and all of drives 410.1-410.7. RAIDs 420 may be the result of capacity advertised to one or more host systems and a request to use the capacity as virtual namespaces supporting the two RAID configurations. Storage node 400 may also allocate a portion of floating namespace pool 416 to a virtual namespace reserved as a hot spare 422 for one or more of the RAIDs. In some configurations, storage node 400 may automatically allocate a portion of initial floating namespace pool 416 to a RAID across the floating namespace pool (RoFNS) 424. For example, based on the available capacity and reservation of the anticipated flexible capacity in unallocated floating namespace pool 418, the storage node may determine an optimized RAID configuration across unused memory locations in drives 410.1-410.7. RoFNS 424 may have the lowest priority and may lose its capacity allocations to support the various namespaces below it in the hierarchy.

As shown in FIG. 4B, an example RAID configuration 470 is distributed across four namespaces 460.1-460.4 in a RAID set 450 to support dynamic allocation, including dynamic allocation for delayed parity writes. Namespaces 460.1 may be in the same storage device or across storage devices in a storage node. In the example shown, all four namespaces 460.1-460.4 may have had the same allocated capacity, such as 1 TB per namespace, and flexible capacity is being used to adjust their guaranteed capacities based on their actual use. For example, each namespace has a different used capacity 462 and floating capacity 466, but the system maintains the same target buffer capacity 464 for each of them. Namespace 460.4 may be a fast filling type namespace and namespace 460.3 may be a slow filling type namespace.

In the example shown, RAID configuration 470 applies a RAID 6 across the four namespaces. For RAID stripes 476.1 and 476.2, host data blocks A 472.1 and C 472.3 are written to namespace 460.1, host data block B 472.2 is written to namespace 460.2, and host data block D 472.4 is written to namespace 460.4. Using delayed parity, these host data blocks may be written as the host data is received and allocated to each RAID stripe 476.1 and 476.2. For example, the storage system may receive and accumulate host data for RAID stripe 476.1 and write host data block A 472.1 and host data block B 472.2, but then delay the writing of delayed parity block AB 474.1 and delayed parity block AB 474.2, leaving RAID stripe 476.1 incomplete. The storage system may continue to receive and accumulate host data for RAID stripe 476.2, while RAID stripe 476.1 remains incomplete due to delayed parity, and write host data block C 472.3 and host data block D 472.4, leaving RAID stripe 476.2 incomplete as well. After a parity write trigger event, a parity block based on host data blocks A and B may be calculated and stored as delayed parity block AB 474.1 in namespace 460.3 and delayed parity block AB 474.2 in namespace 460.4, completing RAID stripe 476.1. A parity block based on host data blocks C and D is calculated and stored as delayed parity block CD 474.3 in namespace 460.2 and delayed parity block CD 474.4 in namespace 460.3, completing RAID strip 476.2. In some configurations, the capacity for the delayed parity may be allocated or reserved for the delayed parity blocks when the host data blocks are written, to ensure that the storage locations are available for completing the RAID stripes. In some circumstances, the allocated capacity of one or more namespaces may be used by the time delayed parity is triggered. In these circumstances, the flexible capacity provided by floating capacity 466 may allow capacity from the floating namespace to be allocated the namespace that was selected to store the delayed parity when the delayed parity is triggered. This RAID configuration and RAID stripe structure is shown as an example, but other RAID level, block parameters, and striping logic may be used.

FIG. 5 schematically shows selected modules of a storage node 500 configured for dynamic allocation of namespace capacity using a floating namespace pool and, more particularly, supporting RAID configurations that advantageously utilize the floating namespace pool. Storage node 500 may incorporate elements and configurations similar to those shown in FIGS. 1-4. For example, storage node 500 may be configured as storage controller 102 and a plurality of storage devices 120 supporting host connection requests and storage operations from host systems 112 over fabric network 114. In some embodiments, the functions of host interface 530, namespace manager 540, and non-volatile memory 520 may all be instantiated in a single data storage device, such as within device controller 130 of one of data storage devices 120. In some configurations, a plurality of hardware and/or software controllers (including hardware and/or software RAID controllers) such as storage controller 102, RAID controller 150 (hardware RAID controller or software RAID controller), and one or more device controllers 130, may operate alone or in combination to execute one or more functions or operations described below.

Storage node 500 may include a bus 510 interconnecting at least one processor 512, at least one memory 514, and at least one interface, such as storage bus interface 516 and host bus interface 518. Bus 510 may include one or more conductors that permit communication among the components of storage node 500. Processor 512 may include any type of processor or microprocessor that interprets and executes instructions or operations. Processor 512 may be comprised of multiple processors or processor cores configured to operate alone or in combination. Memory 514 may include a random access memory (RAM) or another type of dynamic storage device that stores information and instructions for execution by processor 512 and/or a read only memory (ROM) or another type of static storage device that stores static information and instructions for use by processor 512 and/or any suitable storage element such as a hard disk or a solid state storage element.

Storage bus interface 516 may include a physical interface for connecting to one or more data storage devices using an interface protocol that supports storage device access. For example, storage bus interface 516 may include a PCIe or similar storage interface connector supporting NVMe access to solid state media comprising non-volatile memory devices 520. Host bus interface 518 may include a physical interface for connecting to a one or more host nodes, generally via a network interface. For example. host bus interface 518 may include an ethernet connection to a host bus adapter, network interface, or similar network interface connector supporting NVMe host connection protocols, such as RDMA and transmission control protocol/internet protocol (TCP/IP) connections. In some embodiments, host bus interface 518 may support NVMeoF or similar storage interface protocols.

Storage node 500 may include one or more non-volatile memory devices 520 or similar storage elements configured to store host data. For example, non-volatile memory devices 520 may include at least one SSD and/or a plurality of SSDs or flash memory packages organized as an addressable memory array. In some embodiments, non-volatile memory devices 520 may include NAND or NOR flash memory devices comprised of single level cells (SLC), multiple level cell (MLC), triple-level cells, quad-level cells, etc. Host data in non-volatile memory devices 520 may be organized according to a direct memory access storage protocol, such as NVMe, to support host systems storing and accessing data through logical host connections. Non-volatile memory devices 520, such as the non-volatile memory devices of an SSD, may be allocated to a plurality of namespaces 526 that may then be attached to one or more host systems for host data storage and access. Namespaces 526 may be created with allocated capacities based on the number of namespaces and host connections supported by the storage device. In some configurations, namespaces may be grouped in non-volatile memory sets 524 and/or endurance groups 522. These groupings may be configured for the storage device based on the physical configuration of non-volatile memory devices 520 to support efficient allocation and use of memory locations. These groupings may also be hierarchically organized as show, with endurance groups 522 including NVM sets 524 that include namespaces 526. In some configurations, endurance groups 522 and/or NVM sets 524 may be defined to include unallocated capacity 528, such as memory locations in the endurance group or NVM set memory devices that are not yet allocated to namespaces to receive host data. For example, endurance group 522 may include NVM sets 524.1-524.n and may also include unallocated capacity 528.3. NVM sets 524.1-524.n may include namespaces 526.1.1-526.1.n to 526.n.1-526.n.n and unallocated capacity 528.1 and 528.n.

Storage node 500 may include a plurality of modules or subsystems that are stored and/or instantiated in memory 514 for execution by processor 512 as instructions or operations. For example, memory 514 may include a host interface 530 configured to receive, process, and respond to host connection and data requests from client or host systems. Memory 514 may include a namespace manager 540 configured to manage the creation and capacity of namespaces using a floating namespace pool. Memory 514 may include a RAID controller 560 configured to define RAID configurations, allocate host data (from host storage commands) according to the RAID configuration(s), manage delayed parity, and rebuild RAID-stored host data in the event of a device failure. In some configurations, the functions of host interface 530, namespace manager 540, and/or RAID controller 560 may be instantiated in one or more hardware controller devices, operating alone or in combination, comprising bus 510, processor 512, memory 514, storage bus interface, 516, and host bus interface 518 and communicatively connected to at least one host system and at least one data storage device.

Host interface 530 may include an interface protocol and/or set of functions and parameters for receiving, parsing, responding to, and otherwise managing requests from host nodes or systems. For example, host interface 530 may include functions for receiving and processing host requests for establishing host connections with one or more namespaces stored in non-volatile memory 520 for reading, writing, modifying, or otherwise manipulating data blocks and their respective client or host data and/or metadata in accordance with host communication and storage protocols. In some embodiments, host interface 530 may enable direct memory access and/or access over NVMeoF protocols, such as RDMA and TCP/IP access, through host bus interface 518 and storage bus interface 516 to host data units stored in non-volatile memory devices 520. For example, host interface 530 may include host communication protocols compatible with ethernet and/or another host interface that supports use of NVMe and/or RDMA protocols for data access to host data 520.1. Host interface 530 may be configured for interaction with a storage driver of the host systems and enable non-volatile memory devices 520 to be directly accessed as if they were local storage within the host systems. For example, connected namespaces in non-volatile memory devices 520 may appear as storage capacity within the host file system and defined volumes and data units managed by the host file system.

In some embodiments, host interface 530 may include a plurality of hardware and/or software modules configured to use processor 512 and memory 514 to handle or manage defined operations of host interface 530. For example, host interface 530 may include a storage protocol 532 configured to comply with the physical, transport, and storage application protocols supported by the host for communication over host bus interface 518 and/or storage bus interface 516. For example, host interface 530 may include a connection request handler 534 configured to receive and respond to host connection requests. For example, host interface 530 may include a host command handler 536 configured to receive host storage commands to a particular host connection. In some embodiments, host interface 530 may include additional modules (not shown) for host interrupt handling, buffer management, storage device management and reporting, and other host-side functions.

In some embodiments, storage protocol 532 may include both PCIe and NVMe compliant communication, command, and syntax functions, procedures, and data structures. In some embodiments, storage protocol 532 may include an NVMeoF or similar protocol supporting RDMA, TCP/IP, and/or other connections for communication between host nodes and target host data in non-volatile memory 520, such as namespaces attached to the particular host by at least one host connection. Storage protocol 532 may include interface definitions for receiving host connection requests and storage commands from the fabric network, as well as for providing responses to those requests and commands. In some embodiments, storage protocol 532 may assure that host interface 530 is compliant with host request, command, and response syntax while the backend of host interface 530 may be configured to interface with connection namespace manager 540 to provide dynamic allocation of capacity among namespaces.

Connection request handler 534 may include interfaces, functions, parameters, and/or data structures for receiving host connection requests in accordance with storage interface protocol 532, determining an available processing queue, such as a queue-pair, allocating the host connection (and corresponding host connection identifier) to a storage device processing queue, and providing a response to the host, such as confirmation of the host storage connection or an error reporting that no processing queues are available. For example, connection request handler 534 may receive a storage connection request for a target namespace in a NVMe-oF storage array and provide an appropriate namespace storage connection and host response. In some embodiments, connection request handler 534 may interface with namespace manager 540 to update host connection log 552 for new host connections. For example, connection request handler 534 may generate entries in a connection log table or similar data structure indexed by host connection identifiers and including corresponding namespace and other information.

In some embodiments, host command handler 536 may include interfaces, functions, parameters, and/or data structures to provide a function similar to connection request handler 534 for storage requests directed to the host storage connections allocated through connection request handler 534. For example, once a host storage connection for a given namespace and host connection identifier is allocated to a storage device queue-pair, the host may send any number of storage commands targeting data stored in that namespace. Host command handler 536 may maintain queue pairs 336.1 that include a command queue for storage commands going to non-volatile memory devices 520 and a response or completion queue for responses indicating command state and/or returned host data locations, such as read data written to the corresponding host memory buffer for access by the host systems. In some configurations, host command handler 536 passes host storage commands to the storage device command queues and corresponding NVM device manager (not shown) for executing host data operations related to host storage commands received through host interface 530 once a host connection is established. For example, PUT or Write commands may be configured to write host data units to non-volatile memory devices 520. GET or Read commands may be configured to read data from non-volatile memory devices 520. DELETE or Flush commands may be configured to delete data from non-volatile memory devices 520, or at least mark a data location for deletion until a future garbage collection or similar operation actually deletes the data or reallocates the physical storage location to another purpose.

In some embodiments, host command handler 536 may be configured to receive administrative commands related to RAID configuration, such as RAID configuration commands 536.2. For example, RAID controller 560 may receive parameters from host commands related to one or more configuration parameters, such as RAID sets, RAID type, block size, stripe logic, parity, etc. RAID configuration commands 536.2 may be received to create and configure a new RAID configuration. Host command handler 536 may parse RAID configuration commands 536.2 and pass resulting parameters, calls, etc. to RAID controller 560 for execution. In some configurations, host command handler 536 and/or RAID configuration commands 536.2 may include delayed parity parameters 536.3. For example, RAID configuration commands 436.2 may include one or more commands for enabling or disabling delayed parity and/or setting one or more user configurable parameters for managing delayed parity, such as various priority or condition filters, trigger events, and related thresholds, models, and monitors. In some configurations, delayed parity parameters 536.3 may enable or disable a manual parity write trigger event and host command handler 536 may include logic for receiving and parsing a host command for triggering parity write for a RAID set, target host data, or a specific stripe by passing a corresponding event to RAID controller 560. In some configurations, host command handler 536 may include a RAID status interface 536.4 that provides host interface protocols for enabling a host system to check RAID status information. For example, RAID status interface 536.4 may enable host commands for querying or viewing RAID stripe map 564 and/or specific status information for selected RAID sets, host data units, or RAID stripes, including delayed parity and RAID stripe complete notifications.

Namespace manager 540 may include an interface protocol and/or set of functions, parameters, and data structures for defining new namespaces in non-volatile memory devices 520 and managing changes in capacity using a floating namespace pool. For example, namespace manager 540 may receive new namespace requests for a data storage device to allocate the capacity of that storage device among a set of namespaces with allocated capacities of a defined capacity value, such as dividing the 8 TB capacity of a storage device among eight different namespaces. Namespace manager 540 may process command parameters and/or configuration settings for the new namespaces to determine whether and how each namespace supports the floating namespace pool for flexible capacity. For example, each namespace request may include one or more request parameters corresponding to enabling flexible capacity and defining the guaranteed and flexible capacity allocations for that namespace. Once the namespace capacity allocations are defined, namespace manager 540 may monitor and algorithmically and automatically adjust capacity allocations of the set of namespaces by reallocating capacity units from the floating namespace pool to namespaces that need additional capacity. Namespace manager 540 may also send, in cooperation with host interface 530, notifications to host and/or administrative systems as namespace capacities change and/or more capacity is needed. In some configurations, namespace manager 540 may include and/or access an administrative command handler configured to communicate with an administrator system for namespace requests, configuration, and administrative notifications.

In some embodiments, namespace manager 540 may include a plurality of hardware and/or software modules configured to use processor 512 and memory 514 to handle or manage defined operations of namespace manager 540. For example, namespace manager 540 may include and/or access a namespace generator 544 configured to allocate namespaces on non-volatile memory devices 520 in response to namespace requests received through host interface 530 and/or an administrative command handler. For example, namespace manager 540 may include and/or access a namespace allocation log 546 configured to record and maintain capacity allocations for the namespaces and floating namespace pool. For example, namespace manager 540 may include and/or access a flexible capacity manager 550 configured to manage the floating namespace pool and capacity changes for the namespaces. For example, namespace manager 540 may include and/or access a host connection log 552 configured to record and maintain a log of the active host connections for the namespaces.

Namespace generator 544 may include interfaces, functions, parameters, and/or data structures to allocate and configured new namespaces for non-volatile memory devices 520. For example, when a new storage device is added to storage node 500, the storage device may have a storage device configuration that determines a total available capacity and a number of namespaces that can be supported by the device. Namespace generator 544 may receive new namespace request parameters from the administrative command handler and use them to configure each new namespace in the new storage device. In some embodiments, namespace generator 544 may determine a capacity allocation for the namespace. For example, the namespace request may include a capacity allocation value for the new namespace based on how the system administrator intends to allocate the memory space in the storage device’s non-volatile memory devices, such as dividing the memory locations equally among a number of namespaces or individually allocating different allocated capacities to each namespace. Once capacity allocation is determined, a set of memory locations in non-volatile memory devices 520 meeting the capacity allocation may be associated with the namespace. In some configurations, the namespace may be associated with an NVM set and/or endurance group and the memory locations may be selected from the set of memory locations previously assigned to the corresponding NVM set and/or endurance group.

Namespace generator 544 may include initial capacity logic for determining whether a new namespace is participating in the flexible capacity feature of the storage device and make the initial allocations of guaranteed capacity and flexible capacity. The initial capacity logic may use request parameter values related to the namespace creation request to determine the initial capacities and how they are allocated between guaranteed and flexible capacity. One or more flexible capacity flags may determine whether or not the namespace will participate in the floating namespace pool and dynamic capacity allocation. For example, the namespace request may include a flexible capacity flag in a predetermined location in the request message and the value of the flag may be parsed by the admin command handler and passed to namespace generator 544. Where the namespace is part of an NVM set and/or endurance group, the initial capacity logic may check flag values related to the NVM set and/or endurance group to see whether flexible capacity is enabled. In some configurations, these parameters may also determine whether unallocated capacity from the NVM set and/or endurance group may be used to support the floating capacity pool (in addition to the flexible capacity from each participating namespace). For example, namespace generator 544 may check whether the namespace is part of an NVM set or endurance group and check the NVM set or endurance group for the flag, such as the 127^{th} bit of the NVM set list or an NVM set attribute entry for the endurance group. In some embodiments, the flexible capacity flag may be set for the namespace based on a vendor specific field in the namespace create data structure or reserved field of the command Dword. For example, within a vendor specific field defined by the storage protocol specification, such as command Dword 11 of the create namespace data structure, one or more bits may be defined as the flexible capacity flag, with a 1 value indicating that flexible capacity should be enabled for the namespace and a 0 value indicating that flexible capacity should not be enabled for the namespace. Similarly, a reserved field, such as command Dword 11, may include bits reserved for namespace management parameters related to selecting namespace management operations and one of these bits may be used to define a namespace creation operation that enables flexible namespace.

Once a namespace is determined to participate in the flexible capacity and floating namespace pool, initial capacity logic may determine initial values for the guaranteed capacity and the flexible capacity of the namespace. For example, the allocated capacity may be divided between a guaranteed capacity value and a flexible capacity value, where the sum of those values equals the allocated capacity value for the namespace. In some embodiments, each namespace that is not being enabled for flexible capacity may treat its entire capacity allocation as guaranteed capacity. For example, 1 TB namespace would have a guaranteed capacity of 1 TB (all capacity units in the namespace) and a flexible capacity of zero. In some embodiments, the initial capacity logic may use a custom capacity attribute and/or default capacity values to determine the initial capacity values. For example, the namespace request may include a field for a custom capacity attribute containing one or more custom capacity parameter values for setting the guaranteed capacity and/or flexible capacity values. If the custom capacity attribute is not set, then the initial capacity logic may use default capacity values. In some embodiments, the storage system may include configuration settings for default capacity values, such as a default guaranteed capacity value and a default flexible capacity value, such as 50% guaranteed capacity and 50% flexible capacity. In some embodiments, the default capacity values may include a plurality of guaranteed/flexible capacity values that are mapped to different operating types and may receive an operating type used as a key for indexing the default values, such as from an operations analyzer or from an operating type parameter configured in the namespace request. Namespace generator 544 may determine a set of namespace attributes for the new namespace, including the initial guaranteed and flexible capacity values, and provide those namespace attributes to other components, such as a namespace directory used by host systems to connect to the new namespace and/or namespace allocation log 546.

Namespace allocation log 546 may include interfaces, functions, parameters, and/or data structures to store the initial capacity allocation values for new namespaces and manage changes to those values during flexible capacity operations. For example, namespace allocation log 546 may include a data structure or algorithm for indicating the memory locations corresponding to the capacity allocation. Memory allocation 546.1 may indicate the specific sets of memory locations in non-volatile memory 520 and whether they are guaranteed capacity 546.2 or flexible capacity 546.3 for that namespace. As further described below, the memory locations may be reallocated in capacity units over time as the floating namespace pool is used to support expansion of the guaranteed capacity of the namespaces that need it. For example, namespace allocation log 546 may include a map or similar lookup table or function for each namespace’s memory allocation 546.1 and which memory locations or capacity units are currently allocated as guaranteed capacity 546.2 or flexible capacity 546.3.

Flexible capacity manager 550 may include interfaces, functions, parameters, and/or data structures to determine floating namespace pool 550.1 and allocate flexible capacity from the pool to namespaces that need it. For example, once the initial capacity values are determined for the set of namespaces in a storage device, flexible capacity manager 550 may monitor storage operations and/or operating parameters to determine when a namespace has exceeded or is approaching its guaranteed capacity and allocate additional capacity units to that namespace. Floating namespace pool 550.1 may include the plurality of capacity units allocated to flexible capacity for the set of namespaces. For example, flexible capacity manager 550 may include a capacity aggregator 550.2 that sums the capacity units in the flexible capacity portion of each namespace in the set of namespaces to determine the aggregate capacity of floating namespace pool 550.1. In some embodiments, flexible capacity manager 550 may also have access to unallocated capacity from other regions of non-volatile memory devices 520. For example, unallocated capacity may include some or all of unallocated memory locations in one or more NVM sets and/or endurance groups. In this context, unallocated memory locations may be those memory locations that are associated with an NVM set and/or endurance group but are not allocated to a namespace within that NVM set and/or endurance group, such as unallocated memory 528.

Flexible capacity manager 550 may include flexible capacity logic 550.3 that monitors and responds to changes in the capacity used for host data in each namespace. For example, each time a storage operation is processed or on some other time interval or event basis, flexible capacity logic 550.3 may determine the filled mark for the target namespace for the storage operation and/or each namespace and evaluate the filled mark relative to the guaranteed capacity to determine whether additional capacity is needed by that namespace. In some embodiments, flexible capacity logic 550.3 may also include an operating type check to determine one or more operating types for the namespace, such as operating types, as a factor in determining whether additional capacity is need by that namespace and/or from which other namespace’s flexible capacity the additional capacity should come from. For example, flexible capacity logic 550.3 may check whether the namespace is fast filling or slow filling for the purposes of determining when and whether to add guaranteed capacity and/or decrease flexible capacity for a namespace. In some configurations, flexible capacity logic 550.3 may operate on namespaces allocated to a RAID set of namespaces to reallocate capacity among namespaces within the RAID set or to or from other namespaces or unallocated capacity within the storage system.

Flexible capacity manager 550 may use one or more capacity thresholds for determining whether and when capacity should be added to a namespace. For example, flexible capacity manager 550 may use a flexible capacity threshold to evaluate the filled mark for the namespace to trigger the addition of capacity. In some embodiments, the flexible capacity threshold may be set at a portion of the guaranteed capacity, such 50%, 80%, or 90%, with the complementary portion corresponding to a buffer capacity in the guaranteed capacity. So, when the filled mark meets the flexible capacity threshold, such as X% of the guaranteed capacity (or guaranteed capacity - X, if X is a fixed buffer capacity), flexible capacity logic 550.3 selects at least one capacity unit from floating namespace pool 550.1 to expand the guaranteed capacity of that namespace. For example, a number of capacity units at least meeting a difference between the filled mark and capacity threshold (the amount the filled mark is over the capacity threshold). In some embodiments, the flexible capacity thresholds may be based on amount of flexible capacity being used (i.e., the filled mark is allowed to exceed the guaranteed capacity until a threshold amount of flexible capacity is used). For example, the flexible capacity threshold may be set at 50% of the flexible capacity, so when the filled mark meets or exceeds guaranteed capacity + 50% of flexible capacity, the addition of capacity may be triggered. Note that adding capacity units to the namespace increases the total capacity allocation for that namespace, adding new memory locations to memory allocation 546.1. As a result, guaranteed capacity 546.2 and flexible capacity 546.3 may also be recalculated by flexible capacity logic 550.3. For example, the number of added capacity units may be added to the guaranteed capacity (and the flexible capacity may remain unchanged). In some embodiments, guaranteed capacity 546.2 may at least be increased to the current filled mark and/or filled mark plus buffer capacity.

In some embodiments, flexible capacity logic 550.3 may also determine which other namespace the capacity units from floating namespace pool 550.1 are moved from. For example, flexible capacity logic 550.3 may include a guaranteed capacity threshold compared to the filled mark of the source namespace and an operating type of the source namespace to determine whether the capacity units can be spared. In some configurations, flexible capacity logic 550.3 may organize floating namespace pool 550.1 into a prioritized stack of capacity units from the different namespaces and, in some cases, may include unallocated capacity. Flexible capacity logic 550.3 may select the next capacity unit from the stack to provide needed capacity to a target namespace. In some configurations, flexible capacity logic 550.3 may support different FNS pool types that may allocate capacity units from the stack to specific uses. For example, where floating namespace pool 550.1 supports one or more RAID configurations, a portion of floating namespace pool 550.1 may be allocated to one or more hot spares pools for the RAID configurations. In some configurations, virtual namespaces may be allocated out of the floating namespace pool. Virtual namespaces may be configured similarly to namespaces defined through namespace generator 544, except that their memory locations are drawn from the memory stack corresponding to floating namespace pool 550.1.

Host connections log 552 may include interfaces, functions, parameters, and/or data structures to map the namespaces to one or more host connections. For example, after namespaces are created by namespace generator 544, they may be included in a discovery log for storage node 500 and/or the storage device allocated the namespace. Host systems may discover the namespaces in storage node 500 and/or the storage device and request host connections to those namespaces as needed by their applications and determined by storage protocol 532. Responsive to these requests, host systems may be attached to the requested namespaces to allow that host to send storage commands to a queue pair allocated for that host connection. In some embodiments, host interface 530 may use host connection log 552 to determine the host systems and interrupt command paths for host interrupts.

RAID controller 560 may include an interface protocol and/or set of functions, parameters, and data structures for establishing redundant storage of host data using a defined RAID configuration that uses namespaces as the “drives” in the RAID. For example, RAID controller 560 may receive host commands for establishing a RAID-5 or RAID-6 redundant storage scheme across six different namespaces as the RAID set. In some configurations, the six different namespaces may be in the same storage device or they may be distributed across up to six different storage devices. RAID controller 560 may receive one or more commands to create or modify the RAID configuration, then process subsequent host storage commands according to the RAID configuration to store the host data redundantly in the data storage devices. In some configurations, RAID controller 560 may operate on RAID configurations that use data storage devices or other physical or logical volumes as the storage locations in a RAID set and may not be limited to namespaces. In some configurations, RAID controller 560 may also include functions for detecting failed storage devices (and/or no longer accessible “failed” namespaces) and initiate recovery of host data through a RAID rebuild.

In some embodiments, RAID controller 560 may include a plurality of hardware and/or software modules configured to use processor 512 and memory 514 to handle or manage defined operations of RAID controller 560. For example, RAID controller 560 may include a RAID configuration engine configured to determine the redundant storage scheme to be used for storing and accessing host data, such as RAID type/level, participating namespaces, and block, parity, and striping parameters. For example, RAID controller 560 may include a RAID stripe map 564 configured to track the redundant storage of host data blocks according to the RAID configuration for data access and/or RAID rebuild. For example, RAID controller 560 may include delayed parity logic 566 configured to identify RAID stripes to be written with delayed parity and manage the monitoring and triggering of those delayed parity writes. For example, RAID controller 560 may include device operations analyzer 568 configured to monitor and model one or more operating aspects of the RAID set to support delayed parity logic 566. For example, RAID controller 560 may include a RAID rebuild engine 570 configured to rebuild the RAID in response to one or more failed namespaces and/or storage devices hosting those namespaces.

RAID configuration engine 562 may include interfaces, functions, parameters, and/or data structures to determine a RAID configuration for redundantly storing host data written to the set of namespaces in the RAID. For example, RAID configuration engine 562 may support a variety of configuration parameters for defining a RAID configuration and may use a combination of host system or system admin inputs and/or automatically generated parameter settings to define a particular RAID on the storage node. Note that RAID controller 560 and RAID configuration engine 562 may support definition of multiple concurrent RAIDs on storage node 500 using one or more of the storage devices therein and their respective namespaces.

In some configurations, RAID configuration engine 562 supports defining RAIDs across namespaces as the “independent drives/disks” in RAID set 562.1. For example, RAID configuration engine 562 may support selecting a set of namespaces as the RAID nodes of RAID set 562.1. In some configurations, namespace parameters (in a namespace request or namespace metadata) may determine whether a namespace may be used in a RAID configuration. For example, a redundancy flag in the namespace parameters may determine whether capacity from the namespace may be allocated to a RAID. In some configurations, the redundancy flag(s) may support multiple RAID configuration classes, such as a RAID over namespace (RoNS) flag, a RAID over floating namespace (RoFNS) flag, and/or a RAID over virtual namespace (RoVNS) flag. In some configurations, RAID configuration engine 562 may support defining a RAID on a single data storage device as a single drive namespace RAID set 562.1. For example, a storage device may include eight different namespaces and four namespaces may be selected by RAID configuration engine 562 to be organized as a RAID. In some configurations, RAID configuration engine 562 may support defining a RAID across multiple storage devices as a multi-drive namespace RAID set 562.1. For example, six storage devices in an array may each include four namespaces and a RAID with six RAID nodes may be defined using one namespace for each storage device, two namespaces from three different storage devices, or any other combination. RAID configuration engine 562 may automatically select namespaces as RAID nodes and/or receive input from host systems and/or system administrators for determining the specific namespaces in the RAID set. Once the namespaces are determined, RAID configuration engine 562 may determine namespace allocations. For example, RAID configurations engine 562 may access namespace allocation log 546 to determine the total memory allocations, guaranteed capacity, and flexible capacity of each namespace. In some configurations, each namespace may have the same allocated capacity and, in some configurations, different namespaces may have different allocated capacities. Over time, the dynamic allocation of capacity by flexible capacity manager 550 may change namespace allocations to support how host data is actually written across the RAID set.

RAID configuration engine 562 may determine a set of parameters for storing host data across the RAID set of namespaces. For example, RAID configuration engine 562 may be configured with a default set of RAID parameters based on the number of namespaces in the RAID set. In some configurations, the default set of RAID parameters may be determined and/or modified by host systems configured to store data to the RAID and/or responsible system administrators. Example RAID parameters may include a RAID type 562.2, a RAID block size 562.3, stripe logic 562.4, parity calculator 562.5, and/or other parameters for defining the operation of the RAID. RAID type 562.2 may include a parameter corresponding to a standard RAID level for the RAID and/or designation of RAID nodes and mirroring, parity, and/or striping for those nodes. For example, RAID type 562.2 may include RAID 4, RAID 5, and RAID 6 options based on a compatible RAID set of namespaces. RAID block size 562.3 may include one or more parameters for determining the size of the host data blocks to be written to each node in a RAID stripe. For example, RAID block size 562.3 may be a fixed block size or an algorithm for dynamically determining block size based on host data rates and data commit thresholds. Stripe logic 562.4 may include one or more parameters for determining how host data blocks and parity data blocks are written across the set of namespaces in the RAID set. For example, parity may be distributed to designated parity namespaces, rotated (e.g., round-robin, randomized, etc.) among all namespaces, or follow another stripe logic. Stripe logic 562.4 may include parameters for data commit timing or threshold parameters for buffering and/or writing host data blocks, as well as calculating and storing corresponding parity blocks, which may include delayed parity. Parity calculator 562.5 may include parameters for determining how and where parity is calculated. For example, RAID controller 560 and/or specific storage devices may support parity calculation, such as including dedicated parity calculation hardware, and these parameters may define where parity is calculated based on the namespace that will receive the host data and/or parity data blocks. In some configurations, delayed parity may also delay parity calculation. For example, the host data blocks may be written without parity calculation and, when delayed parity storage is triggered, the host data blocks may be read back from their storage locations (or another location if they are still in buffer memory) and directed to the parity calculator. The results of the parity calculation may then be written to the RAID stripe storage locations for those parity blocks. In some configurations, the parity blocks may be calculated at runtime and remain in buffer memory until the delayed parity storage is triggered. Other RAID parameters may be defined for each RAID configuration by RAID configuration engine 562.

RAID stripe map 564 may include interfaces, functions, parameters, and/or data structures to store a host data and parity data index for the RAID. For example, as host data units, such as LBAs, are allocated to RAID data blocks, related parity blocks are calculated, and the RAID stripes are stored across the RAID set, RAID stripe map 564 may store the index data for locating a particular host data unit in a RAID stripe data structure as metadata. In some configurations, as a RAID stripe is written, the host data block identifiers, which may include host LBAs or other host data identifiers and host data RAID block storage location identifiers, may be added to one or more entries in the RAID stripe map. In some configurations, the entries may include timestamps of when the host data blocks are stored. If delayed parity is active for that RAID stripe, a delayed parity indicator may be added to those entries to indicate that the RAID stripe is incomplete and parity data has not yet been calculated and/or committed. In some configurations, parity entries may be made to reserve the storage locations for the delayed parity even though it has not yet been calculated and/or stored to those locations and those parity entries may also include delayed parity indicators to indicate to the system that the parity blocks are incomplete. When a parity write trigger event occurs, the parity data may be written to the RAID stripe storage locations and the RAID stripe completed. The entries corresponding to the RAID stripe and/or its constituent host data blocks and parity blocks may be updated with complete storage location identifiers and/or to remove delayed parity indicators. In some configurations, RAID stripe map 564 and the index and delayed parity indicators it includes may be used to determine which RAID stripes and corresponding delayed parity are selected for completion. For example, a trigger event for the RAID set may involve searching RAID stripe map 564 for each RAID stripe entry with a delayed parity indicator and initiating parity write to sequentially complete those RAID stripes. In another example, if the trigger event targets a specific set of host data, RAID stripe, or a time-based trigger, the index and/or timestamp information in the entries may be used to locate the RAID stripes to be completed. Those parameters may be used in a search of RAID stripe map 564 to identify the RAID stripes corresponding to the trigger event and initiate parity storage and stripe completion. In some configurations, RAID stripe map 564 may also be used by RAID rebuild engine 570 to locate parity, redundant copies, and available host data for recovering data previously stored to a failed namespace.

Delayed parity logic 566 may include interfaces, functions, parameters, and/or data structures to selectively identify RAID stripes that are candidates for delayed parity write operations during host data write operations. This logic may encompass both hardware and software components capable of monitoring RAID stripe status and determining the appropriate timing for initiating parity storage. In some configurations, delayed parity logic 566 may utilize a combination of firmware algorithms and processor-executed instructions to efficiently manage parity write trigger events. In some configurations, priority/condition filter 566.1 may assess the priority level of data within RAID stripes and/or the operating conditions of the system to determine whether delayed parity should be used for that RAID stripe. For example, when host data is received, it may include or be associated with one or more priority classifications, such as high-priority for mission critical data and low-priority for less important data. Priority/condition filter 566.1 may filter out high-priority host data from delayed parity handling. High-priority data may be allocated to a RAID stripe that will receive run-time priority calculation and storage so that the RAID stripe is completed as soon as possible. Low-priority data may be allocated to other RAID stripes that are subject to delayed parity handling. Priority/condition filter 566.1 may also filter RAID stripes at host data storage time based on operating conditions, such as demand and/or device risk. For example, if the system is below a workload threshold and operating resources are idle, there may be no reason to delay parity write and all RAID stripes may be written with run-time parity to store the parity blocks with the host data blocks as they are written—completing each stripe as the host data is received. Similarly, if a number of data storage devices are already at or over their device risk threshold (predicting a higher risk of failure), then delayed parity represents an additional risk of data loss and all RAID stripes may be written with run-time parity to limit that risk. In some configurations, demand monitor 566.4 and/or device risk monitor 566.5 may support operation of any condition filters in place.

In some configurations, time monitor 566.2 may include a timing mechanism for tracking elapsed time relative to the storage of host data blocks and/or absolute time for scheduled delayed parity write. For example, time monitor 566.2 may monitor the system clock and use the current time to determine elapsed time since one or more RAID stripes were written without their parity blocks for comparison against a delay threshold as a parity write trigger event. When the elapsed time meets the delay threshold, for example 1 hour, 12 hours, etc., then time monitor 566.2 generates a parity write trigger event for one or more RAID stripes with delayed parity. In another example, time monitor 566.2 may monitor the system clock for a scheduled time as the time-based threshold, such as 12am, 3am, etc., and when the current time meets the scheduled time, generate a parity write trigger event for one or more RAID stripes with delayed parity.

In some configurations, manual trigger interface 566.3 may include an interface for receiving a manual indication of a parity write trigger event. For example, a host or administrative command may be received through host interface 530 that indicates one or more RAID stripes that have had their parity delayed should proceed with parity storage. For example, a delayed parity write command may be received that indicates a RAID set, RAID stripe, and/or one or more host data units that should have their parity blocks stored. Manual trigger interface 566.3 may receive the parameters from that command, determine the target RAID stripes, and initiate storage of the corresponding parity blocks to complete those RAID stripes.

In some configurations, demand monitor 566.4 and/or device risk monitor 566.5 may include logic for monitoring operating conditions within storage node 500 and its data storage devices to determine conditions for dynamically initiating parity writes. For example, demand monitor 566.4 may monitor the aggregate workload conditions for data storage I/O to determine one or more current workload parameters and compare them to a workload threshold that, when met by a value at or below the threshold, indicates a parity write trigger event because I/O resources are available. For another example, device risk monitor 566.5 may monitor the risk of failure conditions for the data storage devices to determine one or more current device risk parameters and compare them to a risk threshold that, when met by a value at or above the threshold, indicates a parity write trigger event because the likelihood of a failure that would result in data loss has reached unacceptable levels. In some configurations, demand monitor 566.4 and/or device risk monitor 566.5 may use operating parameters and/or aggregate workload or risk metrics collected and/or analyzed by device operations analyzer 568. For example, each monitor may be configured to receive an aggregate metric calculated using a corresponding model based on real-time operating data gathered by device operations analyzer 568. Each monitor is then configured with a corresponding threshold value to use when evaluating the current metric value for one or more parity write trigger events. In some configurations, the monitors may apply different thresholds to different RAID sets, RAID stripes, and/or priorities of host data as indicated by system and/or user-configured delayed parity parameters 536.3. In some configurations, demand monitor 566.4 and/or device risk monitor 566.5 may be used by priority/condition filter 566.1 to conduct a similar comparison based on corresponding metrics and thresholds for determining whether delayed parity should be used when the host data is received. For example, if the workload indicates that resources are available or the device risk indicates that likelihood of failure is high, delayed parity may be disabled for the incoming host data and atomic parity calculation and storage may be used for generating and storing each RAID stripe.

Device operations analyzer 568 may include interfaces, functions, parameters, and/or data structures to analyze the data storage operations, including host data and command types and sizes, queue depths, number of host connections, error rates, storage processing time and/or lag, and lifetime operations (e.g., terabytes written) for determining how the RAID set is performing in terms of quality of service and likelihood of failure. For example, operations analyzer 568 may analyze the host operations to the RAID set to determine whether each namespace has high I/O or low I/O workloads. In some configurations, device operations analyzer 568 may aggregate or otherwise transform the parameters gathered, such as summing, averaging, or taking the highest value of the I/O workload of each data storage device hosting one or more namespaces. Similar processes may be applied to device risk metrics, such as error rates, bad blocks, terabytes written, or device life left, to determine risk of failure metrics for individual and aggregate devices in the RAID set. In some configurations, device operations analyzer 568 may query data storage devices for their operating parameters. For example, device operations analyzer 568 may be configured to access drive self-monitoring, analysis, and reporting technology (SMART) data maintained by each storage device to indicate its current operating conditions. In some configurations, operations analyzer 568 may include or access a dataset management function or service of storage node 500 and/or the specific storage device for determining one or more operating parameters of namespaces in the RAID set. For example, the dataset management function may be configured to process transaction logs to monitor operating parameters, such as read operations, write operations, operations per unit time (e.g., input/output operations per second (IOPS)), memory/capacity usage, endurance metrics, etc. In some configurations, device operations analyzer 568 may include a multi-variable model configured to map or transform a set of operating parameters to aggregate current workload and/or current device risk values for use by delayed parity logic 566. For example, a workload model 568.1 may be configured to gather operating parameters from each data storage device in the RAID set, such as IOPS, host connection count, queue depths, invalid blocks (measuring need to divert resources for garbage collection), and other device operating parameters, to determine a current workload value. As another example, a device risk model 568.2 may be configured to gather operating parameters from each data storage device in the RAID set, such as error rates, bad blocks, terabytes written, device life left, and other device operating parameters, to determine current device risk. In some configurations, device risk model 568.2 may take into consideration the number of devices that may fail in the RAID configuration before data loss would occur. For example, a RAID 6 configuration may be configured to support a number of concurrent failures (where that number is greater than one) and still possess sufficient redundancy to recover the data and, therefore, device risk model 568.2 may discount a single data storage device with high risk metrics and base the current device risk on multiple devices having high risk metrics.

RAID rebuild engine 570 may include interfaces, functions, parameters, and/or data structures to rebuild one or more RAIDs in response to the failure of one or more namespaces in the RAID set. For example, when a namespace becomes unresponsive, such as due to failure of the NVMe device having the physical memory locations of the namespace, the storage device containing the namespace, and/or the communication path to the storage device, RAID rebuild engine 570 may use the host and parity data remaining in the responsive (non-failed) subset of namespaces to rebuild the missing data from the failed namespace. In some configurations, upon determining one or more failures in the RAID set, those namespaces may enter a rebuild status to rebuild the data from the failed namespace to a new namespace, referred to as a hot spare namespace. In some configurations, flexible capacity manager 550 may be configured to allocate and maintain a floating namespace hot spare pool for each RAID that supports floating namespace hot spares. For example, if the allocated namespaces of the RAID set have allocated capacities of 1TB, flexible capacity manager 550 may reserve a set of capacity units in floating namespace pool equal to 1TB to provide hot spare capacity for any needed rebuild. RAID rebuild engine 570 may rebuild the host data and/or parity data blocks from the failed namespace in the hot spare virtual namespace and then advertise and attach the hot spare virtual namespace to the host systems to replace the failed namespace and return the RAID to normal operation.

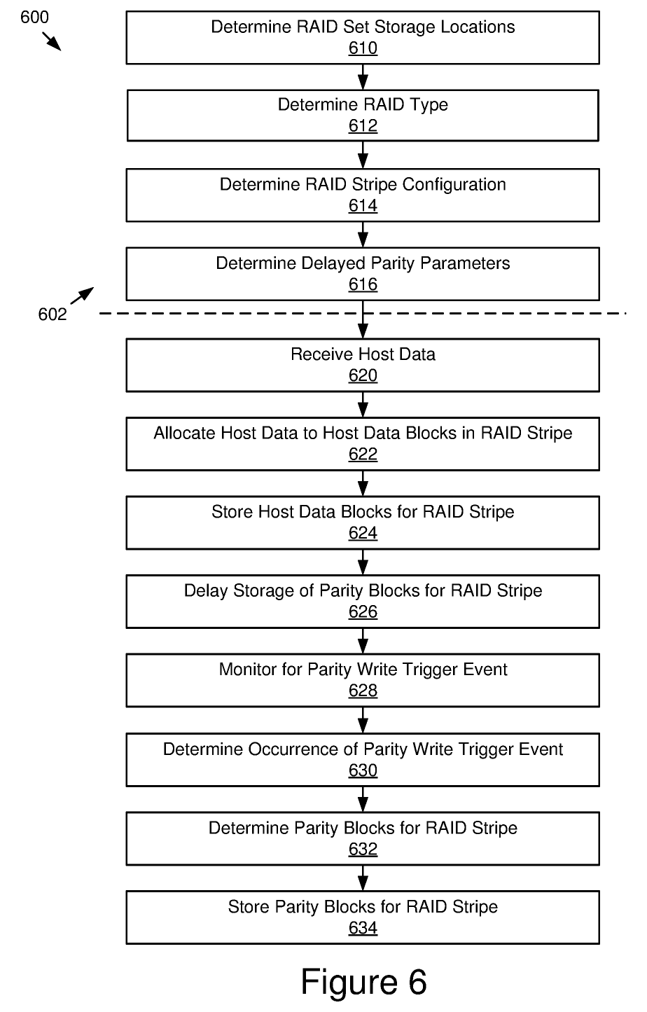

FIG. 6 presents a flowchart of method 600 for implementing delayed parity write in RAID configurations. This method may be executed by components such as RAID controllers within a data storage system, which are configured to manage the timing and execution of parity writes. The method aims to optimize overall system performance by selectively delaying parity operations. The outcome of the method is the improved efficiency of RAID storage operations, particularly during periods of high demand or when system resources are better allocated elsewhere. A RAID configuration method 602 may be executed as part of or prior to the execution of method 600.

At block 610, the RAID set storage locations are determined. For example, the RAID controller may identify the available storage locations across multiple data storage devices that will form the RAID set.

At block 612, the RAID type is determined. For example, the system may select a RAID level, such as RAID 5 or RAID 6, based on the desired redundancy and performance characteristics.

At block 614, the RAID stripe configuration is established. For example, the RAID controller may configure the size and organization of the host data blocks and parity blocks in the RAID stripes, which will dictate how host data is allocated to host RAID blocks, parity is calculated, and the RAID blocks are distributed across the RAID set.

At block 616, the delayed parity parameters are determined. For example, the system may establish the conditions under which parity write operations will be delayed, potentially based on user input or predefined system policies.

At block 620, host data is received. For example, the storage system may accept data from host systems for storage within the RAID configuration.

At block 622, the host data is allocated to host data blocks in the RAID stripe. For example, the RAID controller may map incoming data to specific blocks within a RAID stripe according to the RAID configuration.

At block 624, the host data blocks for the RAID stripe are stored. For example, the storage system may write the data blocks to their respective locations within the RAID set as RAID host data blocks are filled for the RAID stripe.

At block 626, the storage of parity blocks for the RAID stripe is delayed. For example, the system may withhold the storage of parity blocks to a later time, allowing for uninterrupted host data writes during peak activity. In some configurations, the parity may be calculated and stored in a volatile buffer memory but not committed to the RAID stripe storage locations in the non-volatile memory devices. In some configurations, the parity calculation may also be delayed.

At block 628, the system monitors for a parity write trigger event. For example, the RAID controller may watch for conditions that have been established as triggers for initiating delayed parity writes.

At block 630, the occurrence of the parity write trigger event is determined. For example, the system may detect that the predefined conditions for a parity write have been met, such as a low system workload or the passage of a specified time interval.

At block 632, the parity blocks for the RAID stripe are determined. For example, the RAID controller may calculate the parity data based on the stored host data blocks or retrieve the parity data from a volatile buffer memory, if still available.

At block 634, the parity blocks for the RAID stripe are stored. For example, the system may complete the RAID stripe by writing the calculated parity blocks to their designated storage locations within the RAID set.

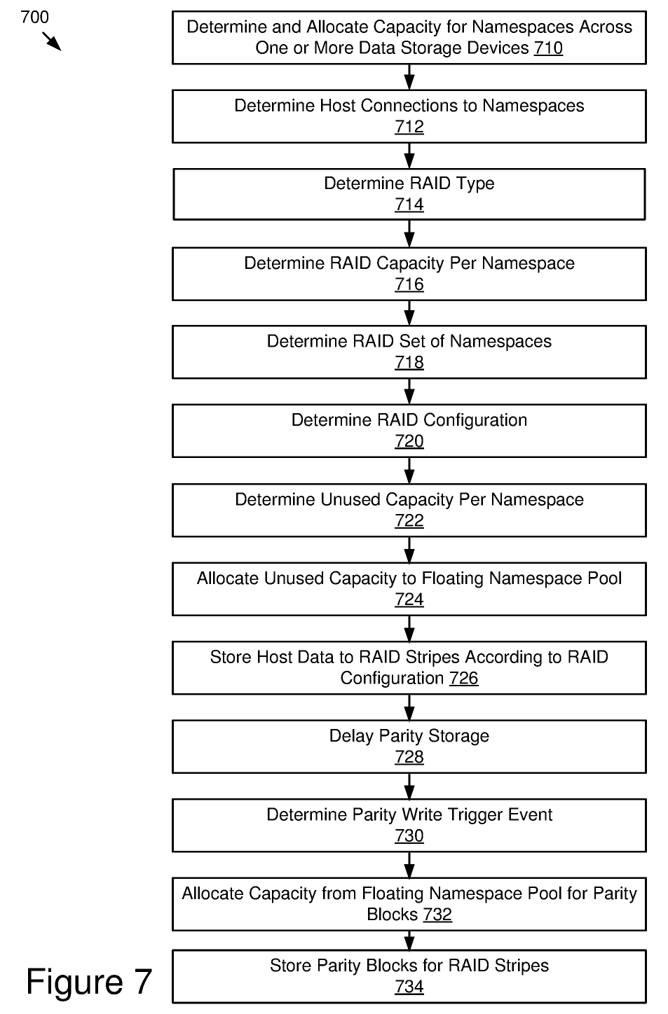

FIG. 7 depicts a flowchart of method 700 for managing RAID configurations and delayed parity storage using a set of namespaces as the RAID set and supported by a floating namespace pool. This method may be executed by a RAID controller or a combination of system components within a data storage system, which are configured to dynamically manage storage capacity and RAID operations. The method facilitates the efficient allocation of storage capacity and the intelligent management of parity storage to enhance RAID performance. The outcome of the method is a RAID system that adapts to storage demands and device conditions, ensuring data integrity while optimizing performance.

At block 710, capacity for namespaces across one or more data storage devices is determined and allocated. For example, the RAID controller may analyze the total available storage and distribute it among various namespaces according to the RAID configuration.

At block 712, a plurality of host connections to the namespaces is determined. For example, the system may establish connections between host systems and the allocated namespaces to facilitate data storage and access.

At block 714, the RAID type is determined. For example, the RAID controller may select an appropriate RAID level, such as RAID 5 or RAID 6, based on the desired redundancy and performance requirements.

At block 716, the RAID capacity per namespace is determined. For example, the system may allocate specific portions of the total namespace capacity to specific RAID configurations and/or individual RAID stripes, ensuring balanced storage distribution.

At block 718, the RAID set of namespaces is established. For example, the RAID controller may group selected namespaces to form a RAID set that will be used for redundant data storage for a particular host system or group of host systems.

At block 720, the RAID configuration is determined. For example, the system may define the parameters of the RAID, such as stripe size, parity distribution, and delayed parity parameters, to optimize data redundancy and system performance.

At block 722, unused capacity per namespace is identified. For example, the system may determine from the namespace allocations for each namespace the amount of storage capacity that is not currently allocated to host data, including the capacity allocated to the RAID set.

At block 724, the unused capacity is allocated to a floating namespace pool. For example, the system may contribute the identified unused capacity to a shared pool that can be dynamically allocated to namespaces as storage demands change.

At block 726, host data is stored to RAID stripes according to the RAID configuration. For example, the RAID controller may write incoming host data to the host data blocks in the RAID stripes, distributing it across the RAID set according to the established RAID configuration.

At block 728, parity storage is delayed. For example, the system may temporarily withhold the storage of parity blocks until a parity write trigger event occurs, allowing for more immediate storage of host data.

At block 730, a parity write trigger event is determined. For example, the RAID controller may monitor system conditions and determine when it is appropriate to initiate the storage of delayed parity blocks.

At block 732, capacity from the floating namespace pool is allocated for storing parity blocks. For example, the system may dynamically allocate additional capacity from the floating namespace pool to store parity blocks when the parity write trigger event occurs.

At block 734, the parity blocks for RAID stripes are stored. For example, the system may complete the RAID stripes by writing the delayed parity blocks to their designated storage locations within the RAID set.

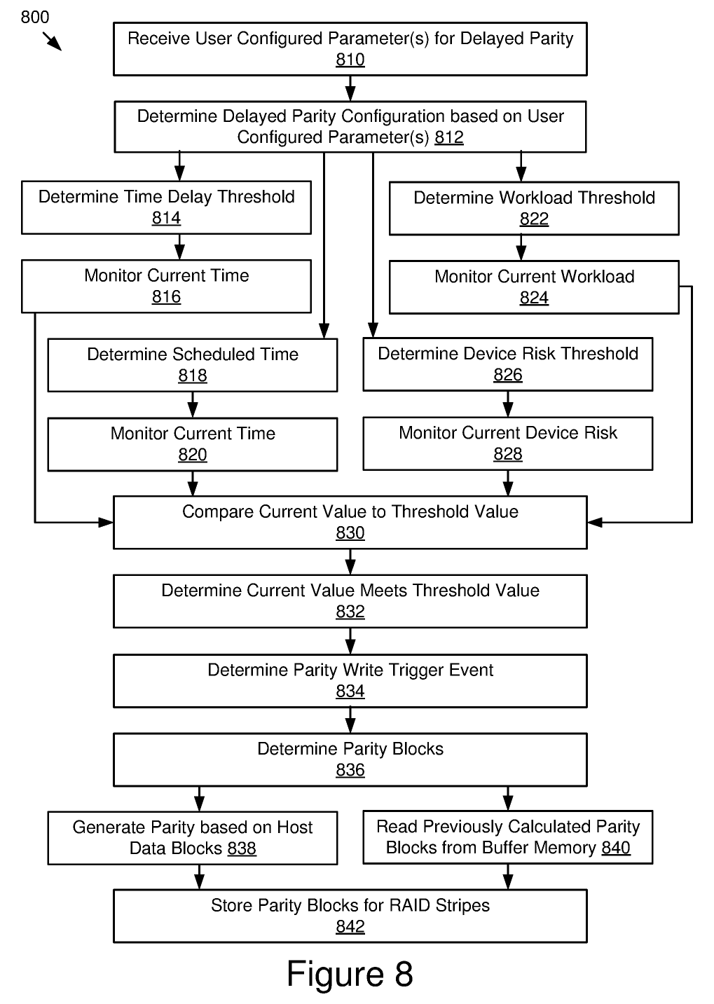

FIG. 8 illustrates a flowchart of method 800 for managing delayed parity in RAID configurations based on different delayed parity parameters. This method may be implemented by a RAID controller within a data storage system, which is configured to utilize user-configured parameters to manage the timing of parity writes. The method is designed to provide flexibility in RAID management by allowing for the adjustment of parity write operations based on various system conditions and user preferences. The outcome of the method is a customizable RAID operation that can adapt to the specific requirements of the data storage environment, optimizing performance and reliability.

At block 810, user-configured parameters for delayed parity are received. For example, the RAID controller may accept settings from an administrator that specify the conditions under which delayed parity writes are to be written.

At block 812, the delayed parity configuration is determined based on the user-configured parameters. For example, the system may analyze the received parameters and establish a delayed parity write policy that aligns with the user's preferences. The resulting delayed parity write policy may include one or more time delays, scheduled times, workload triggers, and/or device risk triggers for parity write trigger events.

At block 814, a time delay threshold is determined. For example, the system may set a specific time period or interval after which parity writes are to be executed, based on the user-configured parameters or a default system parameter.

At block 816, the current time is monitored. For example, the RAID controller may continuously track the system clock to determine when the time-based conditions for a delayed parity write are met.

At block 818, a scheduled time for parity write is determined. For example, the system may establish a specific time of day when parity writes are to be initiated, as per the user-configured parameters or a default system parameter.

At block 820, the current time is monitored. For example, the RAID controller may compare the current time with the scheduled time to decide when to initiate the parity write.

At block 822, a workload threshold for parity write is determined. For example, the system may define a level of system activity, based on one or more operating parameters of the storage system and data storage devices, at which parity writes are to be delayed or executed.

At block 824, the current workload is monitored. For example, the RAID controller may assess the system's workload, based on a workload model, against the defined threshold to determine the appropriate timing for parity writes.

At block 826, a device risk threshold for parity write is determined. For example, the system may set a risk level for storage devices that, when reached, will trigger a parity write to ensure data integrity.

At block 828, the current device risk is monitored. For example, the RAID controller may evaluate the health and performance of storage devices, based on a device risk model, to detect when the risk threshold for parity write is met.

At block 830, the current value is compared to the threshold value. For example, the system may compare the monitored time, workload, or device risk against the respective thresholds to decide if the conditions for a parity write trigger event have been satisfied.

At block 832, it is determined if the current value meets the threshold value. For example, the RAID controller may confirm whether the conditions for initiating a parity write have been met based on the comparison results. Meeting or satisfying the threshold may include equaling, exceeding, or dropping below the target threshold, based on the context and configuration of the particular threshold and comparison values.

At block 834, the parity write trigger event is determined. For example, the system may declare that a parity write trigger event has occurred when one or more current values align with the corresponding thresholds.

At block 836, the parity blocks are determined. For example, the RAID controller may calculate or identify the parity blocks that correspond to the host data blocks awaiting parity writes, such as by searching a RAID stripe data structure for corresponding RAID stripes with delayed parity indicators.

At block 838, parity is generated based on the host data blocks. For example, the system may perform parity calculations for the RAID stripes that have their parity write delayed by reading back the host data from the host data blocks in the RAID stripe or a buffer memory location if the host data is still available there.

At block 840, previously calculated parity blocks are read from buffer memory. For example, the RAID controller may retrieve parity data that was temporarily stored in a buffer awaiting the trigger event.

At block 842, the parity blocks for RAID stripes are stored. For example, the system may complete the RAID stripes by writing the parity blocks to their designated storage locations within the RAID set.

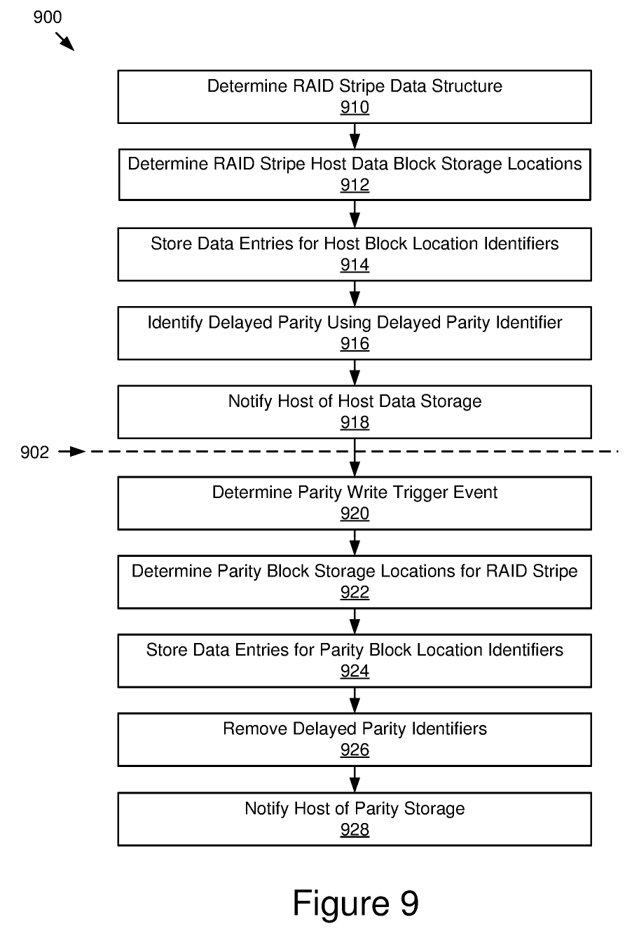

FIG. 9 illustrates a flowchart of method 900 for managing metadata for delayed parity writes in the RAID system. This method may be executed by a RAID controller or related system components within a data storage system, which are configured to manage RAID stripe metadata and delayed parity write operations. The method is designed to enhance the reliability and efficiency of RAID storage by managing the timing of parity writes. The outcome of the method is a RAID system that maintains data integrity while optimizing performance through intelligent parity management.

At block 910, the RAID stripe data structure is determined. For example, the RAID controller may establish a data structure that maps the RAID stripes, including the host data blocks and parity blocks, to their respective storage locations in the RAID set.

At block 912, RAID stripe host data block storage locations are determined. For example, the system may identify the specific storage locations within the RAID set where the host data blocks will be written for a specific RAID stripe.

At block 914, data entries for host block location identifiers are stored. For example, the RAID controller may record the storage locations of the host data blocks in corresponding entries in the RAID stripe data structure to enable cross-referencing of host LBAs with host data blocks in the RAID storage locations.

At block 916, delayed parity is identified using a delayed parity identifier. For example, the system may mark the RAID stripes that have had their parity delayed with a specific identifier that indicates that the parity blocks have not yet been written for that stripe.

At block 918, the host is notified of host data storage. For example, the RAID controller may send a notification to the host system indicating that the host data has been successfully stored. At 902, parity write is delayed until a parity write trigger event is determined.

At block 920, the parity write trigger event is determined. For example, the system may monitor for specific events or conditions that have been established as triggers for initiating delayed parity writes.

At block 922, parity block storage locations for the RAID stripe are identified. For example, the RAID controller may locate the designated storage locations within the RAID set where the parity blocks will be written for the previously written host data blocks.

At block 924, data entries for parity block location identifiers are stored. For example, the system may record the storage locations of the parity blocks in the RAID stripe data structure.

At block 926, delayed parity identifiers are removed. For example, the RAID controller may update the RAID stripe data structure to reflect that the parity blocks have been stored and the RAID stripe is complete.

At block 928, the host is notified of parity storage. For example, the system may send a notification to the host system indicating that the parity blocks have been successfully stored and the RAID stripe is complete.

While at least one exemplary embodiment has been presented in the foregoing detailed description of the technology, it should be appreciated that a vast number of variations may exist. It should also be appreciated that an exemplary embodiment or exemplary embodiments are examples, and are not intended to limit the scope, applicability, or configuration of the technology in any way. Rather, the foregoing detailed description will provide those skilled in the art with a convenient road map for implementing an exemplary embodiment of the technology, it being understood that various modifications may be made in a function and/or arrangement of elements described in an exemplary embodiment without departing from the scope of the technology, as set forth in the appended claims and their legal equivalents.

As will be appreciated by one of ordinary skill in the art, various aspects of the present technology may be embodied as a system, method, or computer program product. Accordingly, some aspects of the present technology may take the form of an entirely hardware embodiment, an entirely software embodiment (including firmware, resident software, micro-code, etc.), or a combination of hardware and software aspects that may all generally be referred to herein as a circuit, module, system, and/or network. Furthermore, various aspects of the present technology may take the form of a computer program product embodied in one or more computer-readable mediums including computer-readable program code embodied thereon.

Any combination of one or more computer-readable mediums may be utilized. A computer-readable medium may be a computer-readable signal medium or a physical computer-readable storage medium. A physical computer readable storage medium may be, for example, but not limited to, an electronic, magnetic, optical, crystal, polymer, electromagnetic, infrared, or semiconductor system, apparatus, or device, etc., or any suitable combination of the foregoing. Non-limiting examples of a physical computer-readable storage medium may include, but are not limited to, an electrical connection including one or more wires, a portable computer diskette, a hard disk, random access memory (RAM), read-only memory (ROM), an erasable programmable read-only memory (EPROM), an electrically erasable programmable read-only memory (EEPROM), a Flash memory, an optical fiber, a compact disk read-only memory (CD-ROM), an optical processor, a magnetic processor, etc., or any suitable combination of the foregoing. In the context of this document, a computer-readable storage medium may be any tangible medium that can contain or store a program or data for use by or in connection with an instruction execution system, apparatus, and/or device.

Computer code embodied on a computer-readable medium may be transmitted using any appropriate medium, including but not limited to, wireless, wired, optical fiber cable, radio frequency (RF), etc., or any suitable combination of the foregoing. Computer code for carrying out operations for aspects of the present technology may be written in any static language, such as the C programming language or other similar programming language. The computer code may execute entirely on a user’s computing device, partly on a user’s computing device, as a stand-alone software package, partly on a user’s computing device and partly on a remote computing device, or entirely on the remote computing device or a server. In the latter scenario, a remote computing device may be connected to a user’s computing device through any type of network, or communication system, including, but not limited to, a local area network (LAN) or a wide area network (WAN), Converged Network, or the connection may be made to an external computer (e.g., through the Internet using an Internet Service Provider).

Various aspects of the present technology may be described above with reference to flowchart illustrations and/or block diagrams of methods, apparatus, systems, and computer program products. It will be understood that each block of a flowchart illustration and/or a block diagram, and combinations of blocks in a flowchart illustration and/or block diagram, can be implemented by computer program instructions. These computer program instructions may be provided to a processing device (processor) of a general purpose computer, special purpose computer, or other programmable data processing apparatus to produce a machine, such that the instructions, which can execute via the processing device or other programmable data processing apparatus, create means for implementing the operations/acts specified in a flowchart and/or block(s) of a block diagram.

Some computer program instructions may also be stored in a computer-readable medium that can direct a computer, other programmable data processing apparatus, or other device(s) to operate in a particular manner, such that the instructions stored in a computer-readable medium to produce an article of manufacture including instructions that implement the operation/act specified in a flowchart and/or block(s) of a block diagram. Some computer program instructions may also be loaded onto a computing device, other programmable data processing apparatus, or other device(s) to cause a series of operational steps to be performed on the computing device, other programmable apparatus or other device(s) to produce a computer-implemented process such that the instructions executed by the computer or other programmable apparatus provide one or more processes for implementing the operation(s)/act(s) specified in a flowchart and/or block(s) of a block diagram.

A flowchart and/or block diagram in the above figures may illustrate an architecture, functionality, and/or operation of possible implementations of apparatus, systems, methods, and/or computer program products according to various aspects of the present technology. In this regard, a block in a flowchart or block diagram may represent a module, segment, or portion of code, which may comprise one or more executable instructions for implementing one or more specified logical functions. It should also be noted that, in some alternative aspects, some functions noted in a block may occur out of an order noted in the figures. For example, two blocks shown in succession may, in fact, be executed substantially concurrently, or blocks may at times be executed in a reverse order, depending upon the operations involved. It will also be noted that a block of a block diagram and/or flowchart illustration or a combination of blocks in a block diagram and/or flowchart illustration, can be implemented by special purpose hardware-based systems that may perform one or more specified operations or acts, or combinations of special purpose hardware and computer instructions.

While one or more aspects of the present technology have been illustrated and discussed in detail, one of ordinary skill in the art will appreciate that modifications and/or adaptations to the various aspects may be made without departing from the scope of the present technology, as set forth in the following claims.

1. A system, comprising:
at least one controller configured to, alone or in combination:
determine a redundant array of independent disks (RAID) configuration comprising a RAID set of storage locations distributed among at least one data storage device, wherein each data storage device of the at least one data storage device comprises a non-volatile storage medium configured to store host data for at least one host system;
store, based on the RAID configuration, host data in at least one stripe set of blocks in the RAID set of storage locations;
delay, responsive to storing the host data in the at least one stripe set of blocks and until a parity write trigger event is determined, storing at least one parity block for each stripe set of blocks in the at least one stripe set of blocks;
determine that the parity write trigger event has occurred; and
store, responsive to the parity write trigger event, the at least one parity block for each stripe set of blocks in the at least one stripe set of blocks.

2. The system of claim 1, wherein:
the set of data storage locations comprises data storage locations in a plurality of namespaces allocated in the at least one data storage device;
the at least one controller is further configured to, alone or in combination, determine a plurality of host connections to the plurality of namespaces in the at least one data storage device; and
each stripe set of blocks and corresponding at least one parity block for the at least one stripe set of blocks are distributed among the plurality of namespaces.

3. The system of claim 2, wherein:
each namespace of the plurality of namespaces has a first allocated capacity;
at least one namespace of the plurality of namespaces allocates a portion of the first allocated capacity to a floating namespace pool; and
the at least one controller is further configured to, alone or in combination, selectively allocate capacity from the floating namespace pool to at least one namespace of the plurality of namespaces for storing the at least one parity block.

4. The system of claim 1, wherein the at least one controller is further configured to, alone or in combination:
determine, based on at least one user configured parameter received from a user, at least one of the following:
a time delay value for determining the parity write trigger event;
a scheduled time value for determining the parity write trigger event;
a workload threshold value for determining the parity write trigger event;
a device risk threshold value for determining the parity write trigger event; and
a manual event parameter for determining the parity write trigger event; and
use the at least one user configured parameter to determine the parity write trigger event.

5. The system of claim 1, wherein:
the at least one stripe set of blocks comprises a first stripe set of blocks;
the at least one controller is further configured to, alone or in combination:
receive the host data for the first stripe set of blocks;
determine a first priority value associated with the host data for the first stripe set of blocks;
receive the host data for a second stripe set of blocks;
determine a second priority value associated with host data for the second stripe set of blocks;
generate, based on the second priority value indicating no delayed parity, a second set of parity blocks for the second stripe set of blocks;
store, without delay, the second set of parity blocks for the second stripe set of blocks; and
generate, based on the first priority value indicating delayed parity and responsive to the parity write trigger event, a first set of parity blocks for the first stripe set of blocks; and
storing the at least one parity block for each stripe set of blocks in the at least one stripe set of blocks includes storing the first set of parity blocks.

6. The system of claim 1, wherein the at least one controller is further configured to, alone or in combination:
store, in a RAID stripe data structure, block location identifiers for each stripe set of blocks in the at least one stripe set of blocks;
identify, in the RAID stripe data structure, the at least one stripe set of blocks with a delayed parity identifier;
store, in the RAID stripe data structure and responsive to the parity write trigger event, parity block location identifiers for each of the at least one parity block for each stripe set of blocks in the at least one stripe set of blocks; and
remove, responsive to storing the parity block location identifiers, corresponding delayed parity identifiers for each stripe set of blocks in the at least one stripe set of blocks.

7. The system of claim 1, wherein:
determining the parity write trigger event comprises a current time value meeting a time-based threshold value;
the time-based threshold value is selected from:
a time delay value; and
a scheduled time value; and
the at least one controller is further configured to, alone or in combination:
monitor the current time value; and
compare the current time value to the time-based threshold value for each stripe set of blocks to determine the parity write trigger event for that stripe set of blocks.

8. The system of claim 1, wherein:
determining the parity write trigger event comprises a current workload value meeting a workload threshold value; and
the at least one controller is further configured to, alone or in combination:
monitor the current workload value; and
compare the current workload value to the workload threshold value for the at least one stripe set of blocks.

9. The system of claim 1, wherein:
determining the parity write trigger event comprises a device risk value associated with the at least one data storage device hosting the RAID set of storage locations meeting a device risk threshold value; and
the at least one controller is further configured to, alone or in combination:
monitor the device risk value for the at least one data storage device; and
compare the device risk value to the device risk threshold value for the at least one stripe set of blocks.

10. The system of claim 9, further comprising:
a plurality of data storage devices in communication with the at least one controller, wherein:
the at least one data storage device comprises the plurality of data storage devices;
monitoring the device risk value comprises:
receiving at least one device parameter from each data storage device of the plurality of data storage devices; and
determining, based on the at least one device parameter, the device risk value for each data storage device of the plurality of data storage devices;
the parity write trigger event occurs if a number of device risk values for the plurality of data storage devices meet the device risk threshold value; and
the number of device risk values is based on a recoverable number of failures for the RAID configuration.

11. A computer-implemented method, comprising:
determining a redundant array of independent disks (RAID) configuration comprising a RAID set of storage locations distributed among at least one data storage device, wherein each data storage device of the at least one data storage device comprises a non-volatile storage medium configured to store host data for at least one host system;
storing, based on the RAID configuration, host data in at least one stripe set of blocks in the RAID set of storage locations;
delaying, responsive to storing the host data in the at least one stripe set of blocks and until a parity write trigger event is determined, storing at least one parity block for each stripe set of blocks in the at least one stripe set of blocks;
determining that the parity write trigger event has occurred; and
storing, responsive to the parity write trigger event, the at least one parity block for each stripe set of blocks in the at least one stripe set of blocks.

12. The computer-implemented method of claim 11, further comprising:
determining a plurality of host connections to a plurality of namespaces allocated in the at least one data storage device, wherein:
the set of data storage locations comprises data storage locations in the plurality of namespaces; and
each stripe set of blocks and corresponding at least one parity block for the at least one stripe set of blocks are distributed among the plurality of namespaces.

13. The computer-implemented method of claim 12, further comprising:
selectively allocating capacity from a floating namespace pool to at least one namespace of the plurality of namespaces for storing the at least one parity block, wherein:
each namespace of the plurality of namespaces has a first allocated capacity; and
at least one namespace of the plurality of namespaces allocates a portion of the first allocated capacity to the floating namespace pool.

14. The computer-implemented method of claim 11, further comprising:
determining, based on at least one user configured parameter received from a user, at least one of the following:
a time delay value for determining the parity write trigger event;
a scheduled time value for determining the parity write trigger event;
a workload threshold value for determining the parity write trigger event;
a device risk threshold value for determining the parity write trigger event; and
a manual event parameter for determining the parity write trigger event; and
using the at least one user configured parameter to determine the parity write trigger event.

15. The computer-implemented method of claim 11, further comprising:
receiving the host data for a first stripe set of blocks, wherein the at least one stripe set of blocks comprises the first stripe set of blocks;
determining a first priority value associated with the host data for the first stripe set of blocks;
receiving the host data for a second stripe set of blocks;
determining a second priority value associated with host data for the second stripe set of blocks;
generating, based on the second priority value indicating no delayed parity, a second set of parity blocks for the second stripe set of blocks;
storing, without delay, the second set of parity blocks for the second stripe set of blocks; and
generating, based on the first priority value indicating delayed parity and responsive to the parity write trigger event, a first set of parity blocks for the first stripe set of blocks, wherein storing the at least one parity block for each stripe set of blocks in the at least one stripe set of blocks includes storing the first set of parity blocks.

16. The computer-implemented method of claim 11, further comprising:
storing, in a RAID stripe data structure, block location identifiers for each stripe set of blocks in the at least one stripe set of blocks;
identifying, in the RAID stripe data structure, the at least one stripe set of blocks with a delayed parity identifier;
storing, in the RAID stripe data structure and responsive to the parity write trigger event, parity block location identifiers for each of the at least one parity block for each stripe set of blocks in the at least one stripe set of blocks; and
removing, responsive to storing the parity block location identifiers, corresponding delayed parity identifiers for each stripe set of blocks in the at least one stripe set of blocks.

17. The computer-implemented method of claim 11, further comprising:
monitoring a current time value; and
comparing the current time value to a time-based threshold value for each stripe set of blocks to determine the parity write trigger event for that stripe set of blocks, wherein:
determining the parity write trigger event comprises the current time value meeting the time-based threshold value; and
the time-based threshold value is selected from:
a time delay value; and
a scheduled time value.

18. The computer-implemented method of claim 11, further comprising:
monitoring a current workload value; and
comparing the current workload value to a workload threshold value for the at least one stripe set of blocks, wherein determining the parity write trigger event comprises the current workload value meeting the workload threshold value.

19. The computer-implemented method of claim 11, further comprising:
monitoring a device risk value for the at least one data storage device; and
comparing the device risk value to a device risk threshold value for the at least one stripe set of blocks, wherein determining the parity write trigger event comprises the device risk value associated with the at least one data storage device hosting the RAID set of storage locations meeting the device risk threshold value.

20. A system comprising:
a processor;
a memory;
means for determining a redundant array of independent disks (RAID) configuration comprising a RAID set of storage locations distributed among at least one data storage device, wherein each data storage device of the at least one data storage device comprises a non-volatile storage medium configured to store host data for at least one host system;
means for storing, based on the RAID configuration, host data in at least one stripe set of blocks in the RAID set of storage locations;
means for delaying, responsive to storing the host data in the at least one stripe set of blocks and until a parity write trigger event is determined, storing at least one parity block for each stripe set of blocks in the at least one stripe set of blocks;
means for determining that the parity write trigger event has occurred; and
means for storing, responsive to the parity write trigger event, the at least one parity block for each stripe set of blocks in the at least one stripe set of blocks.
